(19) United States
(12) Patent Application Publication
(10) Pub. No.: US 2016/0171786 A1
(43) Pub. Date: Jun. 16, 2016

(54) FARE REFUND SYSTEM, AND METHOD FOR SAME

(71) Applicant: HITACHI, LTD., Tokyo (JP)

(72) Inventors: Rieko OTSUKA, Tokyo (JP); Kei SUZUKI, Tokyo (JP); Koji ARA, Tokyo (JP)

(73) Assignee: HITACHI, LTD., Tokyo (JP)

(21) Appl. No.: 14/904,811

(22) PCT Filed: Sep. 6, 2013
(86) PCT No.: PCT/JP2013/074162

§ 371 Date: Jan. 13, 2016

(51) Int. Cl. G07B 15/02; G06Q 20/40

(52) U.S. Cl. CPC G07B 15/02; G06Q 20/407

(57) ABSTRACT

A fare refund system includes a standard movement pattern generation unit that collects a movement log of a passenger utilizing a transport facility and generates a standard movement pattern of the passenger based on a normal-time movement log of the transport facility in the collected movement log; a transport failure information acquisition unit that acquires information about a failure influenced area and time band associated with a transport failure; an influence presence/absence determination unit that determines the presence or absence of an influenced movement log in the collected movement log; a loss degree calculation unit that calculates the degree of loss for the passenger based on a difference between the standard movement pattern and the influenced movement log when it is determined by the influence presence/absence determination unit that there is the influenced movement log; and a refund unit that pays a refund fare corresponding to the calculated loss degree.

### TECHNICAL FIELD

The present invention relates to fare refund systems and methods used for transport failures in public transport facilities such as railroads, and buses.

### BACKGROUND ART

Because public transport facilities, such as railroads and buses, have large transport capacities, if the operation of any one of public transport facilities changes due to transport failures such as a disaster, an accident resulting injury or death, and a failure, a large number of passengers are adversely affected to a great degree. Especially in major cities and the like where railroad networks are highly developed, it is natural that the risk of accident occurring should be high, therefore how to lessen social effects brought about by transport failures has become a significant issue. When any transport failure occurs, a relevant transport operator is required to control the confusion developed among passengers, and also required to guide the passengers in an appropriate manner. However, in the present circumstances, typical countermeasures are the guidance for the passengers, the provision of transport transfer means, and the like.

The provision of the transport transfer means is to provide railroad passengers, who meet predefined conditions such as a condition of having a ticket including a tied-up transport section, and the like, with a free ticket for riding another transfer facility (another railroad or a bus). However, in most cases, only passengers who bought tickets including a tied-up transport section before the accident occurs are passengers who meet the predefined conditions, and it is not always possible for everyone to enjoy a refund service. In addition, in order for an eligible passenger to enjoy the relevant transport transfer service, he/she has to present a ticket, a commuter pass, or a IC card of his/her own to a station attendant, and has to receive a transport transfer ticket, or he/she has to make a fare adjustment or the like later at a station counter, therefore there is a problem in that it takes time for he/she to perform the above works. Furthermore, the amount of money compensated at a transport transfer is essentially the amount of difference between the actually needed fare and the original fare. In view of such a circumstance, there are not a few passengers who take roundabout paths at their own expenses. In addition, because station attendants have to deliver transport transfer tickets and recover original tickets by hand, it becomes a problem in that it is a heavy burden on the station attendants to perform the above works, and the accuracy of acquiring passengers who are affected by the transport failure becomes low.

Patent Literature 1 discloses a transport transfer expense adjustment system in which expenses needed for transport transfers can be accurately calculated.

Patent Literature 2 discloses a system in which delay damages are calculated by obtaining the differences between times required due to the effects of stagnant events such as accidents and congestions on the basis of passage times at tollbooths recorded by ETCs.

Patent Literature 3 discloses a system in which evaluation results about predefined evaluation items, such as an absolute delay time; a delay time for each station; the number of trains having erroneous transport intervals between themselves and their adjacent trains; the number of trains having erroneous overtaking marginal distances between themselves and their adjacent trains; a refund cost; the number of trains whose operations are stopped; and the degrees of annoyance to customers, are quantitatively obtained, and the evaluation values of respective evaluation items obtained by normalizing the above evaluation results are three-dimensionally displayed.

### CITATION LIST

### Patent Literature

Patent Literature 1: Japanese Patent Application No. 2005-223313

Patent Literature 2: Japanese Unexamined Patent Application Publication No. 2009-69882

Patent Literature 2: Japanese Unexamined Patent Application Publication No. Hei 7(1995)-132830

### SUMMARY OF INVENTION

### Technical Problem

Technology disclosed in Patent Literature 1 is intended to be applied to transport transfer, and increases in times required in association with the transport transfer of passengers are not taken into consideration. Because technology disclosed in Patent Literature 2 is intended to be applied to users of expressways, there is essentially one type of moving path from a certain point to another certain point, and damages associated with delay times relative to the average time required by vehicles are taken into consideration. However nothing is taken into consideration about an alternative moving path. Technology disclosed in Patent Literature 3 is applied to a calculation method for calculating the degree of influence exercised on passengers on the basis of operation diagrams and delay information about trains, and moving behaviors of the passengers are not taken into consideration in this technology.

### Solution to Problem

A fare refund system disclosed in the present invention includes: a standard movement pattern generation unit for collecting a movement log of a passenger utilizing a transport facility and generating a standard movement pattern of the passenger on the basis of a normal-time movement log of the transport facility in the collected movement log; a transport failure information acquisition unit for acquiring information about a failure influenced area and a failure influenced time band associated with the development of a transport failure by the transport facility; an influence presence/absence determination unit for determining the presence or absence of an influenced movement log in the collected movement log which is the movement log of the passenger in the transport failure area and the failure influenced time band; a loss degree calculation unit for calculating the degree of loss for the passenger associated with the transport failure on the basis of a difference between the standard movement pattern and the influenced movement log when it is determined by the influence presence/absence determination unit that there is the influenced movement log; and a refund unit for paying back a refund fare corresponding to the calculated loss degree and associated with the development of the transport failure by the transport facility.

### Advantageous Effects of Invention

According to the present invention, time, cost, and others can be reflected in a refund fare in association with the degree of loss obtained by comparing the standard movement pattern and the influenced movement log of the passenger.

### BRIEF DESCRIPTION OF DRAWINGS

FIG. 1 is a schematic view showing a way for a passenger to change his/her moving behavior due to a transport failure.

FIG. 2 is a block diagram of a fare refund system.

FIG. 3 is a chart for illustrating a flow for calculating the degree of loss for a passenger who is affected by a transport failure on the basis of the usage data of a transport facility.

FIG. 4 is a diagram showing IC card data.

FIG. 5 is a diagram showing position data.

FIG. 6 is a diagram showing master data that is fundamental information about stations, tracks, and paths.

FIG. 7 is a schematic view for illustrating the relations among a section and paths.

FIG. 8 is a diagram showing an area definition list.

FIG. 9 is a diagram showing movement log data.

FIG. 10 is a diagram showing a processing procedure for generating a movement log.

FIG. 11 is a diagram showing another processing procedure for generating a movement log.

FIG. 12 is a diagram showing standard movement pattern data.

FIG. 13 is a diagram showing a processing procedure for extracting a standard movement pattern.

FIG. 14 is a diagram showing a transport failure information table.

FIG. 15 is a diagram showing a loss degree calculation result table.

FIG. 16 is a diagram showing a processing procedure for extracting a passenger who is affected by a transport failure.

FIG. 17 is a diagram showing a processing procedure for calculating the degree of loss for a passenger who is affected by a transport failure.

FIG. 18 is a diagram showing a compensation fare table.

FIG. 19 is a diagram showing a processing procedure for calculating a refund fare.

FIG. 20 is a diagram showing an example of a login screen of a refund fare guidance system.

FIG. 21 is a diagram showing a processing procedure for performing refund processing.

FIG. 22 is a diagram showing an example of a screen for illustrating calculation reasons for refund fares.

FIG. 23 is a diagram showing an example of another screen for illustrating calculation reasons for refund fares.

FIG. 24 is a diagram showing an example of a screen for comparing loss degree distributions of plural accident cases.

FIG. 25 is a diagram showing an example of a screen for visualizing the changes of loss degrees for individual sections regarding an accident case.

### DESCRIPTION OF EMBODIMENTS

An example of a fare refund system, in which passengers (also referred to as users) who are affected by a transport failure and the degrees of losses for the passengers are quantitatively calculated, and refund fares are calculated corresponding to the magnitudes of the influences exerted on the passengers, will be explained with reference to the accompanying drawings.

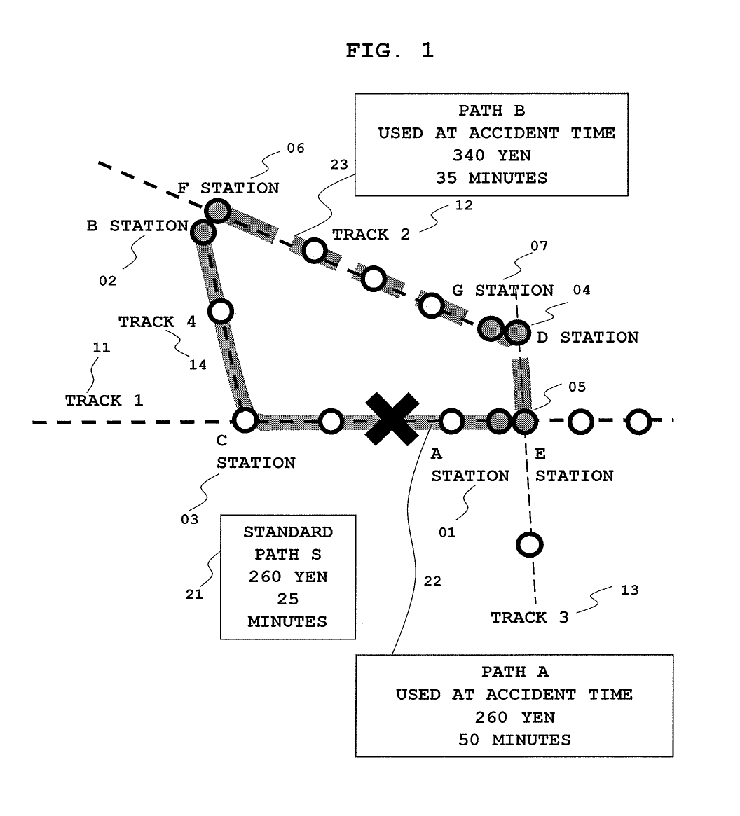

FIG. 1 is a schematic view showing a way for a passenger to change his/her moving behavior due to a transport failure (also simply referred to as a failure). A station A (01), a station B (02), a station C (03), a station D (04), a station E (05), a station F (06), a station G (07), and a track 1 (11), a track 2 (12), a track 3 (13), a track 4 (14) are disposed as shown in FIG. 1, and it will be assumed that one can make his/her way on foot between the station A (01) and the station E (05), between the station B (02) and the station F (06), and between the station D (04) and the station G (07) respectively. In the following description, although a railroad network will be explained as an example for the sake of a simple explanation, this embodiment can be applied not only to a railroad network but also to all kinds of public transport networks including a bus network.

It will be assumed that a normal-time standard moving method (a standard path) from the station A (01) to the station B (02) is a method for a passenger to use a path S (21) in which the passenger goes from the station A (01) to the station C (03) via the track 1 (11), transfers to the track 4 (14) at the station C (03), and goes to the station B (02) via the track 4 (14). When the transport between the station A (01) and the station C (03) is temporarily tied up due to a failure on the track (11), the passenger who wants to move from the vicinity of the station A to the vicinity of the station B has two choices.

One choice is a way to use a path A (22) that is the same as the standard path after waiting in the vicinity of the station A until the operation on the track 1 (11) is resumed. In this case, it is anticipated that a time required becomes larger than the time required at normal times under the influence of a failure due to an accident or the like.

The other choice is a way to use another path B (23) in which the passenger goes from the station E (05) to the station D (04) via the track 3 (13) and transfers to the track 2 (12) at the station G (07) and goes to the station F (06). Such a path is typically referred to as a detour path, and this detour rout, which is scarcely used at normal times, often puts the passenger at a disadvantage by imposing a longer time required, and a larger fare. In either case, once a transport failure occurs, it is anticipated that the passenger will suffer some sort of loss in comparison with his/her normal-time movement.

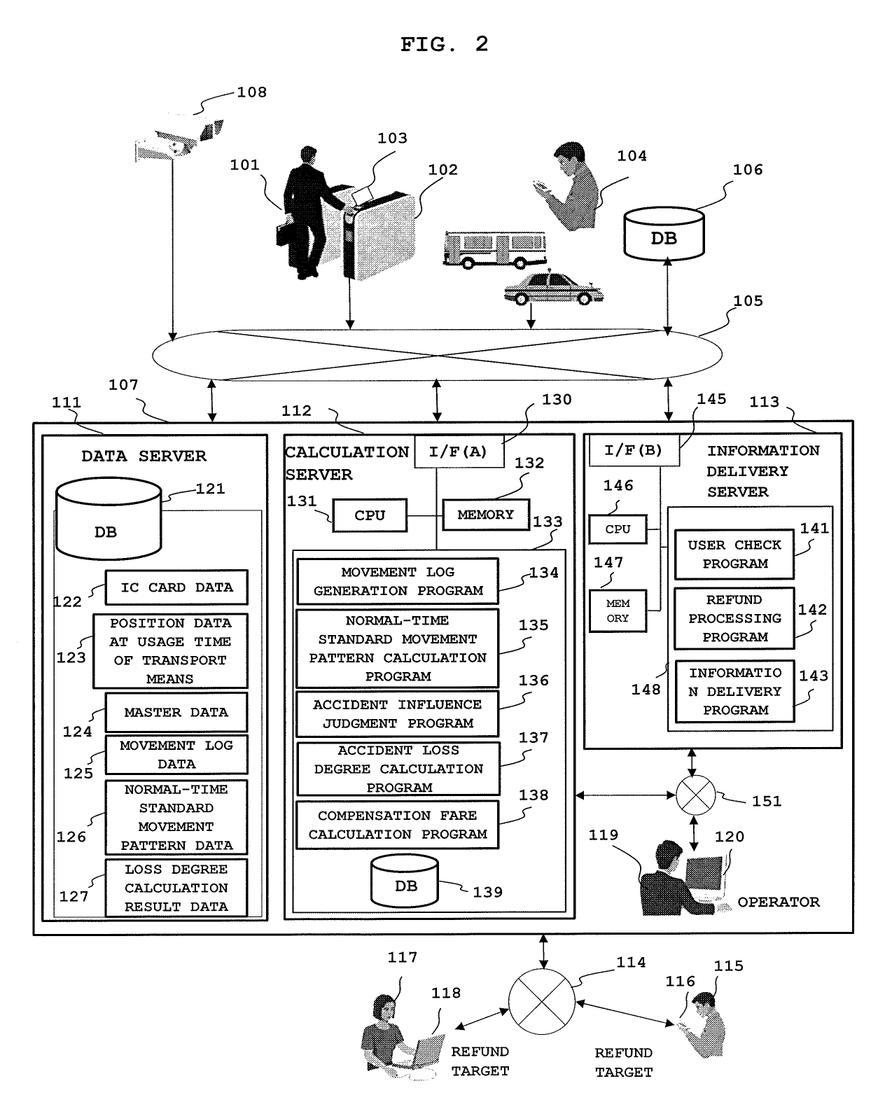

FIG. 2 is a block diagram of a fare refund system in which passengers who are affected by a transport failure are distinguished, compensation fares are calculated according to the individual degrees of losses, and refund processing is performed for the passengers. In recent years, many users (101), who use transport facilities, pass through automatic ticket gates (102) installed for transport facilities or read terminals installed in vehicles using non-contact IC cards, or mobile terminals (103) which have the same functions as those of the non-contact IC cards. Data pieces acquired at those automatic ticket gates or read terminals are transmitted to an external data server (106) managed by the relevant transport operators via a network (105).

Furthermore, it is typical that a high-functioning mobile terminal or the like which is rapidly wide-spread in recent years has a function for acquiring and transmitting position information using GPS, and a transport operator can collect such position information by the external data server (106) via the network (105) under the permission of a user (104). Actually, an application, which is used for guiding a traffic path on the basis of the position information of the user, or the like has been widely used. In addition, there are many cases where monitoring cameras (108) are installed in the premise and in the vicinity of a station recently, therefore it is also possible that a user is specified and his/her position information can be estimated and stored from image data photographed and recorded by such cameras.

A fare refund system (107), which calculates the degree of loss associated with a transport failure and pays back a refund fare corresponding to the loss, includes a data server (111); a calculation server (112); and an information delivery server (113), and the fare refund system (107) stores usage data collected by non-contact IC cards and by mobile terminals (103) which have the same functions as those of the non-contact IC cards, the position information of users, and movement data estimated and collected from videos of monitoring cameras and monitoring research, and performs analysis processing on the stored data. Here, explanations about the functions, configurations, and image processing technologies regarding the non-contact IC cards, automatic ticket gates, and monitoring cameras, which are not directly related to the explanation of this embodiment, will be omitted.

When a user (101), who has a non-contact IC card or a mobile terminal (103) having the same function as that of a non-contact IC card, passes through an automatic ticket gate (102), a user ID, which distinguishes individual non-contact IC cards or mobile terminals (103) having the same function as that of a non-contact IC card, and position information including the passage date of the user are stored in the automatic ticket gate (102), and these data pieces are stored in the external data server (106) managed by the transport operator as original data. Hereinafter, a non-contact IC card or a mobile terminal (103) having the same function as that of a non-contact IC card, will be referred to as an IC card (103) for simplicity. A non-contact IC card is also referred to as a transport IC card. An IC card (103) has information identifying the card such as a user ID and the like, and the information is read out by an automatic ticket gate (102). A read machine such as an automatic ticket gate (102) stores read time (passage date at the automatic ticket gate) and position information (position of the automatic ticket gate) in the read machine (the automatic ticket gate) itself in parallel with reading out information for identifying the card.

The position information of a user (104) (for example, position information recognized by the GPS function of the mobile terminal) and video data of the monitoring camera (108) are similarly stored in the external data server (106). Those data pieces are stored, and at the same time, those data pieces are transmitted to the data server (111), or the necessary parts of those data pieces are transmitted to the data server (111) with an appropriate timing such as every other hour or every other day via the network (105). The fare refund system (107), which is comprised of the group of servers including the data server (111), the calculation server (112), and the information delivery server (113), is coupled to the network 105, and can hold communication with the transport operator and users (115, 117). Here, although this embodiment is described under the assumption that the group of servers includes the data server (111), the calculation server (112), and the information delivery server (113), it is also possible that this embodiment is configured in such a way that one server or plural servers can perform the functions of this group of servers.

The data server (111) receives data pieces of users, which are read by IC card reader terminals (read machines) such as automatic ticket gates, and position data estimated by the GPS functions of mobile terminals and from videos and the like obtained by monitoring cameras via the network (105), and stores these data pieces in a data storage unit (121). Data pieces collected and stored include IC card data (122), position data (123) at the usage time of a transport means estimated by the GPS functions of mobile terminals and from videos and the like obtained by monitoring cameras, fundamental master data (124) regarding to stations, bus stops, and tracks, and the like. Furthermore, movement log data (125), which is obtained by primarily processing the IC card data (122), the position data (123) at the usage time of a transport means estimated by the GPS functions of mobile terminals and from the videos and the like obtained by monitoring cameras, normal-time standard movement pattern data (126) generated by collecting and analyzing the movement log data (125), data of the degrees of losses (127) for passengers who are affected by a transport failure, and the like are stored.

If the fundamental master data (124) regarding stations, bus stops, and tracks are changed or updated, these changed or updated data pieces are appropriately input from external, and the fundamental master data pieces (124) are updated and recorded. Because these IC card data (122) and position data (123) at the usage time of a transport means estimated by the GPS functions of mobile terminals and from the videos and the like obtained by monitoring cameras include the position data of users, these data pieces are stored with adequate attention paid to the privacies of the users so that the respective users cannot be identified by, for example, encrypting, or anonymizing these data pieces.

The calculation server (112) performs processing for generating movement logs from data stored in the data server (111), processing for generating normal-time standard movement pattern data, processing for extracting passengers who are affected by a transport failure and for calculating the degrees of losses for the passengers, and the like. The calculation server (112) mainly includes a network interface (I/F (A)) (130), a CPU (131), a memory (132), and a memory unit (133). The network interface is an interface for the calculation server to be coupled to the network. The memory unit (133) includes: a group of programs comprised of a movement log generation program (134), a normal-time standard movement pattern calculation program (135), a failure influence judgment program (136), a failure-time loss degree calculation program (137), a compensation fare calculation program (138), and the like; results of calculation processing; and a data storage unit (139) for storing obtained statistical values and index values. The memory unit can be, for example, a hard disk drive, a CD-ROM drive, or a flash memory. Here, it is conceivable that the above various programs and data are divided and the divided programs and data are stored in plural recording devices.

When each program is executed, analysis target data is read out from the data server (111), and temporarily stored in the memory (132), and the program (134, 135, 136, 137, or 138) is read out by the CPU (131) in the memory, and each function is realized by executing the relevant program. It is conceivable that timings of executing these programs are, for example, timings when the transport operator (119) or passengers (115, 117) make requests, or timings when new data is added to the data server (111). Alternatively, these programs can be automatically executed at scheduled times every day as batch programs.

The information delivery server (113) includes network interfaces (I/F (B)) (145); a CPU (146); a memory (147); and a recording device (148). The network interfaces are interfaces for the information delivery server to be coupled to the network. The recording device is a device for recording various programs and various data and, it is, for example, a hard disk drive, a CD-ROM drive, or a flash memory. Here, it is conceivable that the above various programs and data are divided and the divided programs and data are stored in plural recording devices.

The information delivery server (113) is used for a passenger (115, or 117) to check users, to search for refund fare information for passengers affected by failures, and to refer to the search results using a mobile information terminal (116), or a home-use or public information terminal (118) via the Internet (114). A user (115, or 117) can be identified by a user check program (141) in such a way that the user holds up his/her IC card (103) to an IC card reader, the user ID read out from the IC card by the IC card reader is transmitted to the information delivery server (113) via the Internet (114), and the information is passed to the user check program (141). The recording device (148) includes the user check program (141), a refund processing program (142), and an information delivery program (143). The CPU (146) realizes various functions by reading out various programs, which are stored in the recording device (148), in the memory, and executing these programs. To put it concretely, check the user ID read out from the IC card against the user ID (or the card ID) in data stored in the data server (111) is performed using the user check program (141), and a search processing program is executed on the basis of the checked data, with the result that fare refund processing associated with a failure by which the user is affected is performed, and loss degree calculation information is processed, and the processed loss degree calculation information is provided to the user. These pieces of information are fundamentally obtained at a timing at which each user actively makes access to the fare refund system.

The transport operator (119), who possesses the fare refund system (107), which calculates the degree of loss associated with a transport failure and pays back a refund fare corresponding to the loss, can check the configuration and status of various stored data; the status and calculation results of the calculation server, the status of search requests from users, and the like via a network (151) using an information terminal (120). In addition, the transport operator (119) can update a fare table used for inputting transport failure data and for refunding fares.

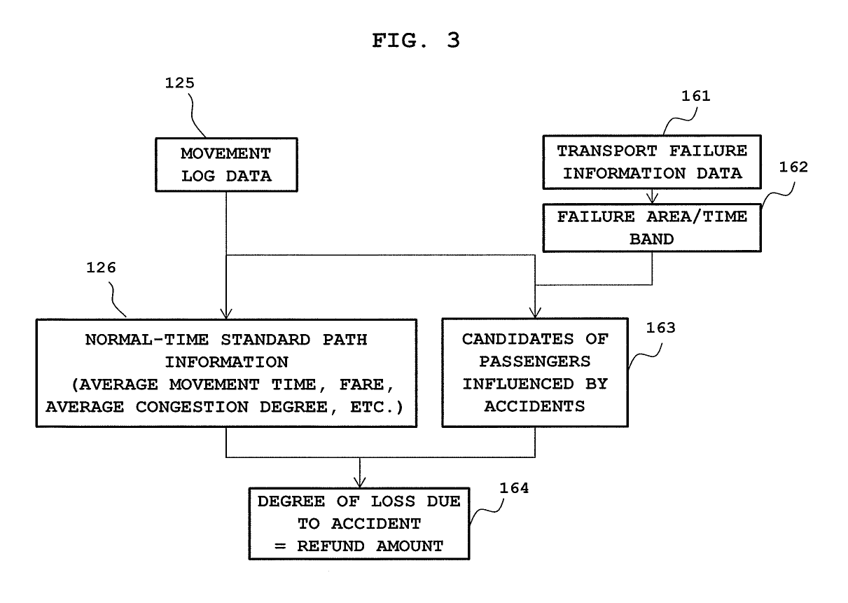

FIG. 3 is a schematic diagram of a flow for calculating the degree of loss for a passenger who is affected by a transport failure on the basis of the usage data of a transport facility. The fare refund system according to this embodiment judges whether or not a passenger, who was moving during a transport failure, was affected by the influence of the failure (163) by comparing normal-time standard movement pattern data (126) as a reference value with a path used at the transport failure using movement log data (125) including the transport behaviors of passengers, and at the same time, calculates a loss degree associated with the failure, that is, the amount of a refund fare (164). In order to calculate a normal-time standard path and to extract passengers affected by a transport failure, transport failure information data (161), which shows when and where the transport failure occurred, is required. The transport failure data (161) includes information (162) about a failure occurrence area and a time band during which a transport operation is disturbed due to the failure, and using these pieces of information, areas in which transport operations was normally performed, and time bands during which transport operations was normally performed are extracted, with the result that the normal-time standard movement pattern data (126) is generated using a movement log.

The processing shown in FIG. 3 can be described as follows if the processing is described from the standpoint of the processing units which execute the processing shown in FIG. 3. The fee refund system includes: a standard movement pattern generation unit for collecting a movement log of a passenger utilizing a transport facility and generating a standard movement pattern of the passenger on the basis of a normal-time movement log of the transport facility in the collected movement log. The processing performed by the standard movement pattern generation unit includes a piece of processing in which the IC card data of the passenger is collected and a movement log is generated from the collected IC card data. Furthermore, the fare refund system includes: a transport failure information acquisition unit for acquiring information about a failure influenced area and a failure influenced time band associated with the development of a transport failure by the transport facility; an influence presence/absence determination unit for determining the presence or absence of an influenced movement log in the collected movement log which is the movement log of the passenger in the transport failure area and the failure influenced time band; a loss degree calculation unit for calculating the degree of loss for the passenger associated with the transport failure on the basis of a difference between the standard movement pattern and the influenced movement log when it is determined by the influence presence/absence determination unit that there is the influenced movement log; and a refund unit for paying back a refund fare corresponding to a calculated loss degree and associated with the development of the transport failure by the transport facility. Here, the influenced movement log is the movement log of the passenger in the failure influenced time band in the transport failure area associated with the development of the transport failure by the transport facility.

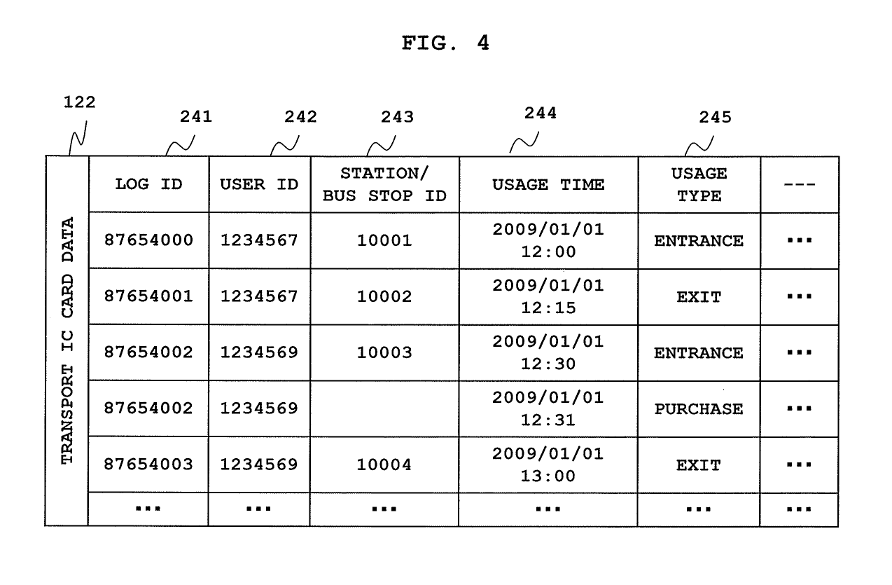

FIG. 4 is a diagram showing the constitution of IC Card Data (122) that is typical data stored in the data server (111). First, the IC card data includes information about Log ID (241); User ID (242); Station/Bus Stop ID (243) that is associated with information about a data reading terminal through which the relevant user passes; Usage Time (244) that shows times when the user passes through the reading terminal; and Usage Type (245) that shows whether the relevant IC cards are used for “Entrance” or “Exit”; and the like. Here, Usage Type shows information showing a processing type, for example, “Entrance” or “Exit” in the case of an automatic ticket gate or an entrance/exit gate, “Purchase” in the case of a sales terminal, or the like. The IC Card Data (122) can be transmitted every time new data is generated, or can be transmitted in a lump in the middle of the night when the network is less used. It is all right if the storage processing of the transmitted IC card data is performed at the timing of transmitting the IC card data on the data server side (111).

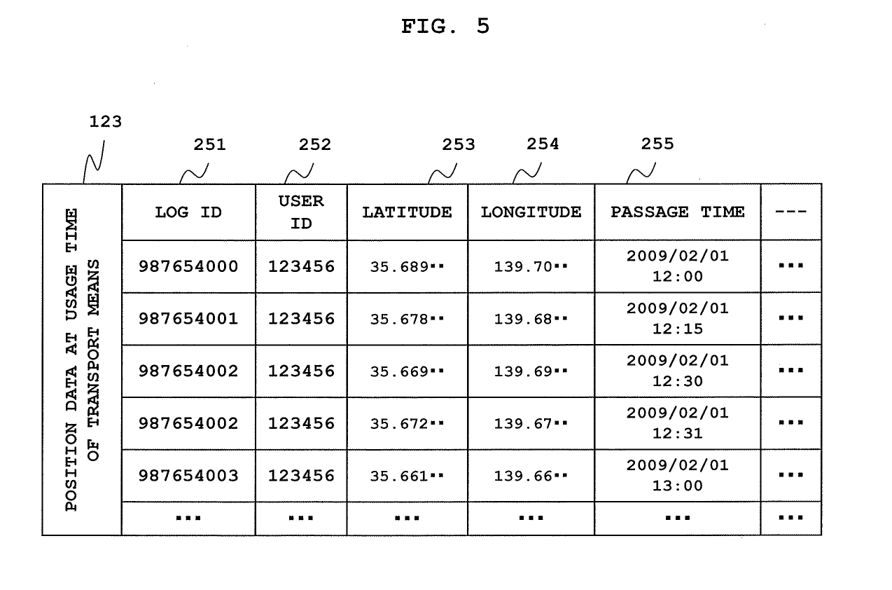

FIG. 5 is a diagram showing typical position data stored in the data server (111). Position data (123) at the usage time of a transport means includes information about Log ID (251); User ID (252); Latitude Information (253) and Longitude Information (254) that are associated with information about a point through which the relevant user passes; Passage Time (255) that shows when the user passes through the point; and the like. Here, User ID shows information associated with a user such as the card ID of the user's IC card, the device ID of the user's mobile information terminal, the user's member ID of a position information acquisition application, or the like. Position data (123) at the usage time of a transport means is, for example, such data as is latitude and longitude information that is obtained/transmitted manually or automatically at a certain intervals and stored when the user is on a train, an automobile, a bus, or the like. On the other hand, applying facial recognition technology and person tracking technology to videos obtained by monitoring cameras installed in the premise and vicinity of a station makes it possible to convert the video data of a certain passenger whose facial image and the like have been registered in advance into position data showing a fact that the passenger was at a certain place at a certain time. In other words, the video data of the passenger is converted into information for specifying the passenger (user ID), and at the same time, the video data of the passenger is associated with the acquired position information.

Position data (123) at the usage time of a transport means can be transmitted every time new data is generated, or can be transmitted in a lump in a time band when the network is less used. It is all right if the storage processing of the transmitted position data is performed at the timing of transmitting the position data on the data server side (111).

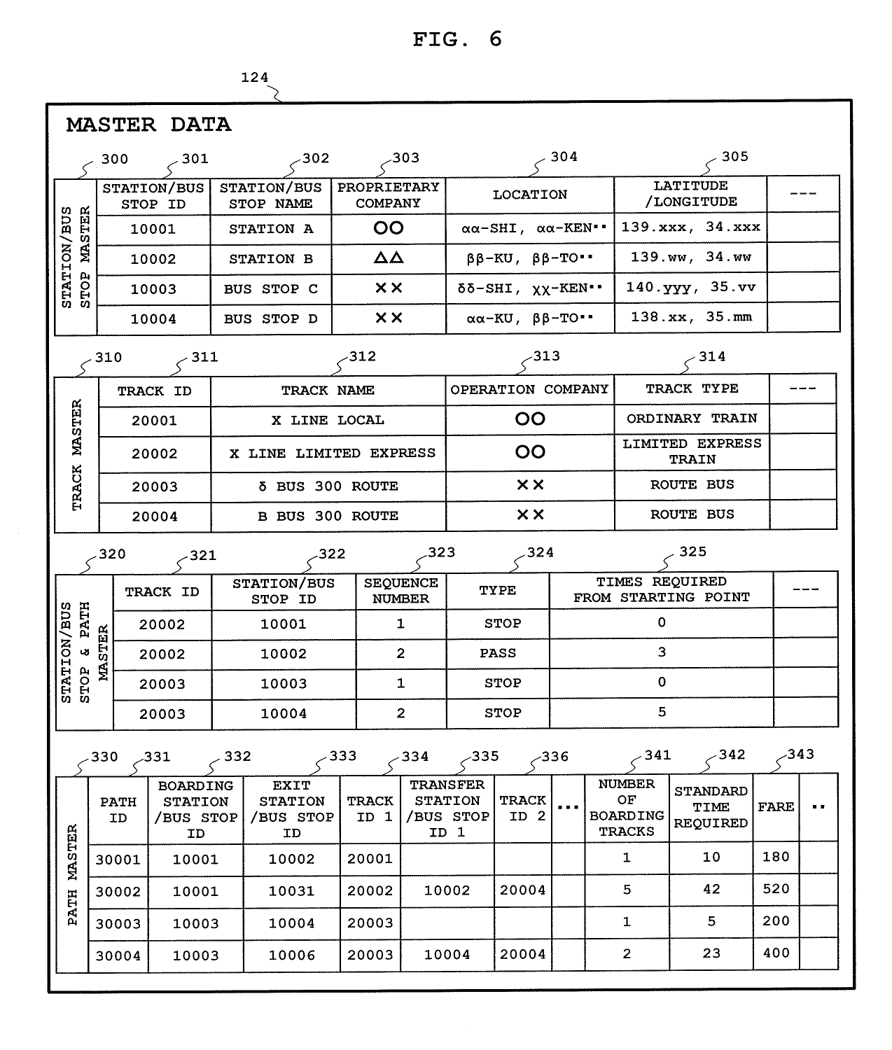

FIG. 6 is a diagram showing the types of Master Data (124) stored in the data server (111) and the constitutions of individual data. First, Station/Bus Stop Master (300), which is fundamental data about sites where transport means, such as stations, bus stops, and roads can be used, includes information about Station/Bus Stop ID (301); Station/Bus Stop Name (302); Proprietary Company (303); Location (304) such as an address; information about Latitude/Longitude (305); and the like. If the configurations of stations, bus stops, or roads are changed, addition or alternation to Position Master is performed.

Track Master (310), which is fundamental data about tracks, includes information about Track ID (311) that identifies individual paths; Track Name (312); Operation Company (313); Track Type (314) that distinguishes a railroad track from a bus track; and the like.

Relation between Station/Bus Stop and Track Master (320), which is fundamental data to associate stations with racks, includes information about Track ID (321) that identifies individual tracks; Station/Bus Stop ID (322) that identifies individual stations and bus stops included in individual tracks; Sequence Number (323) that manages the orders of stations/bus stops; Type (324) that shows whether each train or bus stops at individual stations/bus stops or not; Times Required from Starting Point (325). Starting Point shows a transport origin defined for each track, and it shows the starting station or bus stop of the track.

Furthermore, Path Master (330), which is fundamental data about paths, includes information about Path ID (331) that identifies individual paths; Boarding Station/Bus Stop ID (332); Exit Station/Bus Stop ID (333), and information about Track IDs (334, 336, . . . ) and Transfer Station/Bus Stop IDs (335, . . . ) whose numbers are equal to the number of boarding tracks. In the case where a passenger moves from Boarding Station/Bus Stop (332) to Exit Station/Bus Stop (333), if a transport facility is used only once, data is stored in Path ID1 (334) that identifies which track for the passenger to board on. In addition, in the case where a passenger moves from Boarding Station/Bus Stop (332) to Exit Station/Bus Stop (333), if plural transport facilities are used, data specified by Path ID1 (334) that identifies which track for the passenger to board on; Transfer Station/Bus Stop ID1 (335) that identifies individual transfer points; Path ID2 (336) that shows a track for the passenger to next board on; and the like are sequentially stored in accordance with the value of Number of Boarding Tracks (341). Furthermore, Path Master includes information about Number of Boarding Tracks (341), Standard Time Required (342), fare (343), and the like that show comprehensive information about this track. Here, in some cases, there are plural paths corresponding to a combination of Boarding Station/Bus Stop ID (332) and Exit Station/Bus Stop ID (333). However, it will be assumed that a path that is usually most frequently used is assigned to the first path this time. If plural paths are assigned to a combination of Boarding Station/Bus Stop ID (332) and Exit Station/Bus Stop ID (333), it is conceivable that each of the paths is given its own usage rate. For example, if a station, a bus stop, a track, or a road is changed, the change is input into Master Data (124) from the external of the system shown in FIG. 2, and Master Data (124) is updated and recorded every time the change occurs.

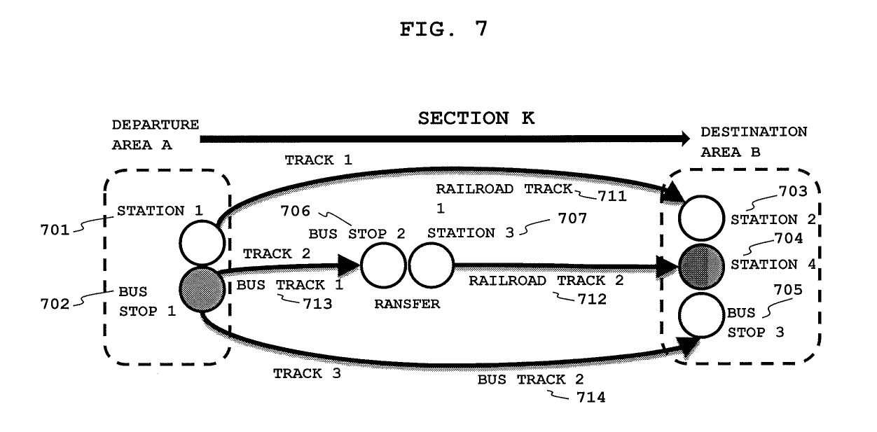

FIG. 7 is a diagram schematically showing relations among stations, bus stops, tracks, a section and paths in a railroad network and a bus track network. Generally speaking, plural stations of plural railroad companies and bus stops of plural bus companies closely exist in a railroad network and a bus track network. There exist many so-called transfer stations. For example, Bus Stop 1 (702) exists in the vicinity of Station 1 (701); Station 2 (703), Station 4 (704), and Bus Stop 3 (705) exist adjacently within walking distance from one another; and Station 3 (707) and Bus Stop 2 (706) exist adjacently within walking distance from each other. In addition, it will be assumed that there are two paths from Station 1 (701) to Station 2 (703); one is Path 1 in which a passenger goes from Station 1 (701) to Station 2 (703) via Railroad Track 1 (711) is used, and the other is Path 2 in which the passenger goes to Bus Stop 2 (706) via Bus Track 2 (706), transfers to Railroad Track 2 (712) at Station 3 (707) and reaches Station 4 (704). Furthermore, it will be assumed that there is Path 3 in which a man goes from Bus Stop 1 (702) to Bus Stop 3 via Bus Track 2 (714). In other words, if a user wants to move from the vicinity of Station 1 to the vicinity of Station 2, there are two choices, that is, Station 1 (701) and Bus Stop 1 (702) in Departure Area A, and there are three choices, that is, Station 2 (703), Station 4 (704), and Bus Stop 3 (705) in Destination Area B. Furthermore, there are three choices, that is, Path 1, Path 2, and Path 3, between the vicinity of Station 1 to the vicinity of Station 2. Here, a line that connects a certain departure area and a certain destination area is referred to as a section, and a route along which a man can move between the departure area and the destination area is defined as a path. Treating an area instead of a station or a bus stop as a unit finally makes it possible to treat plural paths as comparison targets.

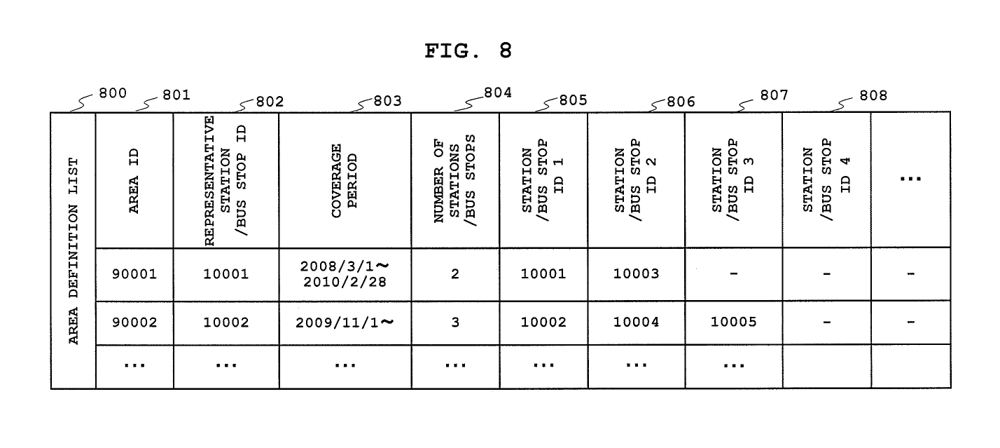

FIG. 8 is a diagram showing a data constitution for storing area definition data used for regarding a group of transferable points, which are explained with reference to FIG. 7, as the same area. Area Definition List (800) includes information about Area ID (801) that identifies individual records; Representative Station/Bus Stop ID (802) included in the area; Coverage Period (803) during which this definition is effective; Number of Stations/Bus Stops (804) included in the area; Station/Bus Stop ID1 (805) included in the area; Station/Bus Stop ID2 (806); Station/Bus Stop ID3 (807); Station/Bus Stop ID4 (808); and the like. Because transport networks such as stations, bus stops, tracks, roads, and the like change with times, it is necessary that new definitions should be made in accordance with the changes of the transport networks. However, when transport data is analyzed, it is necessary that area definition information corresponding to the date of the data should be read out. Therefore, it becomes important to set the valid period of the data defined by coverage period (803). Information about in which area a certain station or a certain bus stop is included can be created on the basis of latitude and longitude information of Station/Bus Stop Master data (300) and a threshold regarding the distance, or can be created by a transport operator or the like on the basis of his/her experience. Alternatively, each transport operator can define the information in his/her own right.

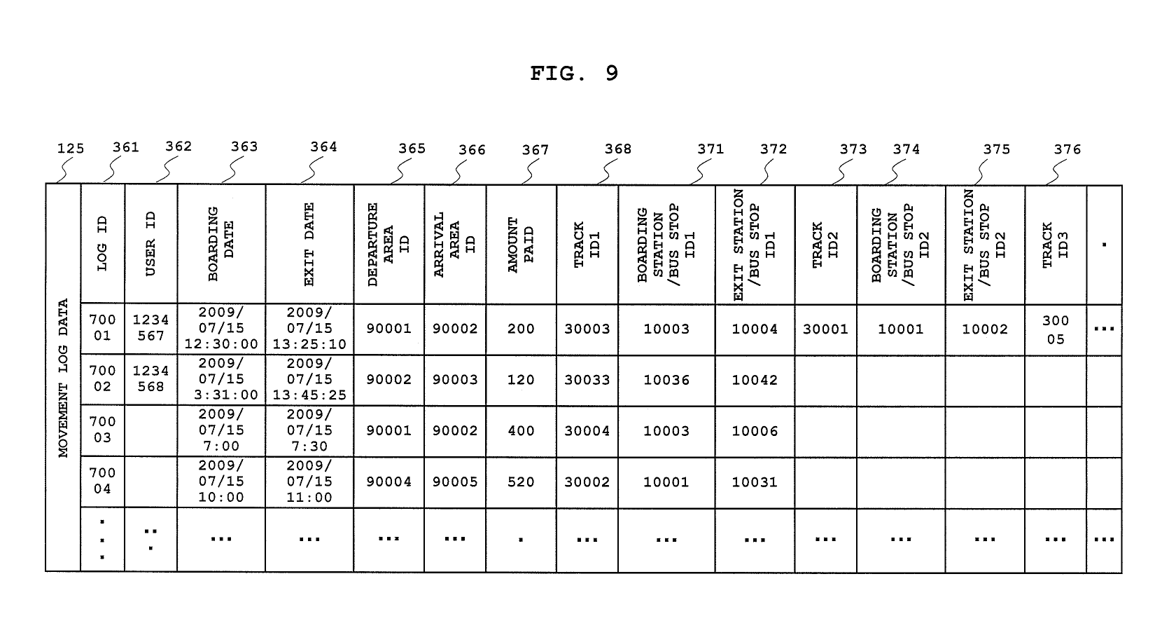

FIG. 9 is a diagram showing a data constitution for storing movement log data (125) stored in the data server (111). Movement Log Data (125) includes information about Log ID (361) that identifies individual logs; User ID (362); Boarding Date (363) that shows the date for starting the use of a transport means at a departure place; Exit Date (364) that shows the date for ending the use of a transport means at a arrival place; Departure Area ID (365); Arrival Area ID (366); Amount Paid (367) that shows a fare spent for a movement; Path ID1 (368); Boarding Station/Bus Stop ID1 (371); Exit Station/Bus Stop ID1 (372); Path ID2 (373); Boarding Station/Bus Stop ID2 (374); Exit Transfer Station/Bus Stop ID2 (375); Path ID3 (376); and the like. This Movement Log Data (125) is primarily processed data that is generated using IC Card Data (122) and Position data (123) at usage time of a transport means.

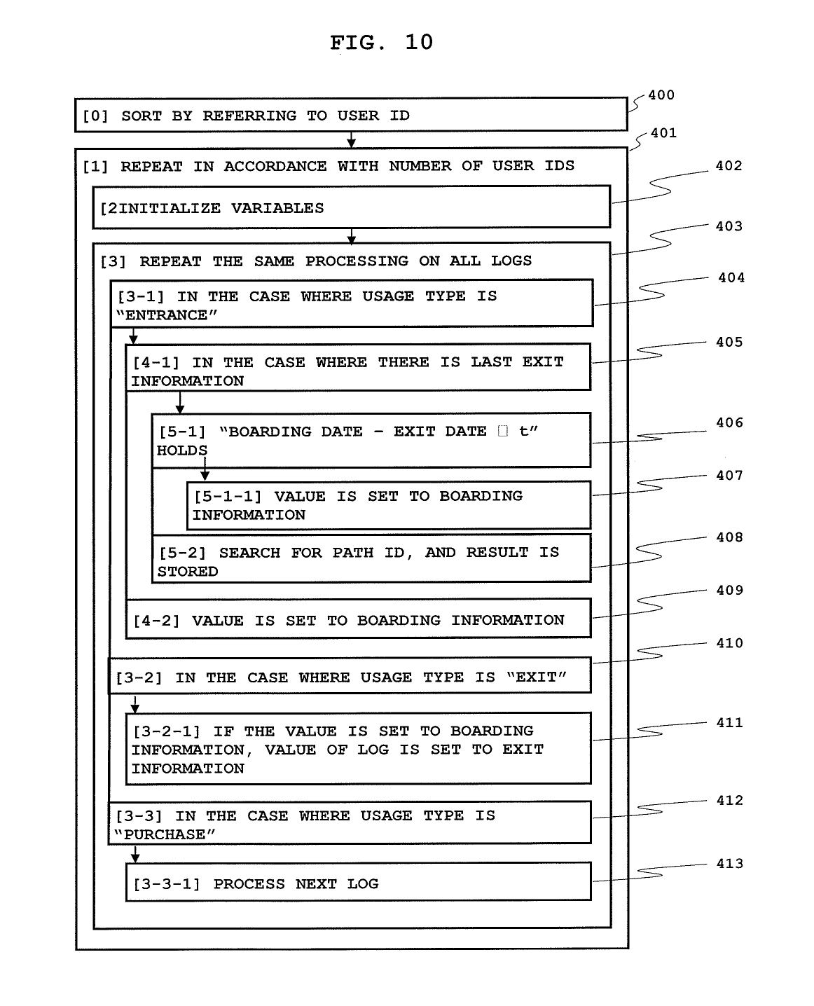

FIG. 10 is a diagram for illustrating a procedure in which Movement Log Data (125) is generated from IC Card Data (122), and stored in the data sever (111) (movement log generation processing). In this case, the following description will be made under the assumption that the storage processing of Movement Log Data to the data server (111) is performed once a day at a predefined time. First, all data pieces are sorted in accordance with the order of user IDs and the order of times by referring to User ID (242) and Usage Time (244) included newly collected IC Card Data (122) (Processing Step 400). Next, the following same processing is repeated on the data sorted at Processing Step 400 in accordance with the number of user IDs (Processing Step 401).

First, list-type variables corresponding to Boarding Station/Bus Stop ID, Boarding Date, Exit Station/Bus Stop ID, Exit Date are initialized (Processing Step 402). Next, the following same processing is repeated on the data sorted in accordance with times (Processing Step 403). First, the data pieces are classified in accordance with the values of Usage Type (245). If the value of Usage Type (245) is “Entrance” (Processing Step 404), the last exit log of logs of the same user and of the same day is referred to (Processing Step 405) first, it is judges whether or not the difference between the exit date of the exit log and the boarding date of the current log is within a predefined threshold. This threshold is a value for judging whether there are one or more transfers across plural transport facilities or not, and it is desirable that the value is set within several minutes to several tens of minutes. If the difference between the exit date of the last exit log and the boarding date of the current log is within the threshold (Processing Step 406), it is considered that a series of movements is continuing, and a value is set to the lists of Boarding/Bus Stop ID and Boarding Date (Processing Step 407). If the difference exceeds the threshold, because an adequate time has elapsed from the last movement, it is judged that the last movement information should be considered to be separated. Therefore, Path ID that coincides with a combination of Boarding Station/Bus Stop ID and Exit Station/Bus Stop ID is searched for with reference to the values of Boarding Station/Bus Stop ID, Boarding Date, Exit Station/Bus Stop ID, and Exit Date and using Path Master (330), and the search result is stored in Movement Log Data (125) (Processing Step 408). If there is no relevant last exit log, the above judgment processing is omitted, and a value is set to the lists of Boarding/Bus Stop ID and of Boarding Date (Processing Step 409).

If the value of Usage Type (245) is “Exit” (Processing Step 410), a value is set to the variables of Exit/Bus Stop ID and Exit Date (Processing Step 411). Here, Log ID (361) is held as a serial number. Here, it will be assumed that the threshold t used for judging whether a series of movements is continuing or not is set in advance as a standard transfer time. By using this threshold t, the allowable range of transfer time can be adjusted. The threshold t regarding a standard transfer time is a positive value, and it can be set for all transport networks as a common value, or the threshold t can have different values for individual areas.

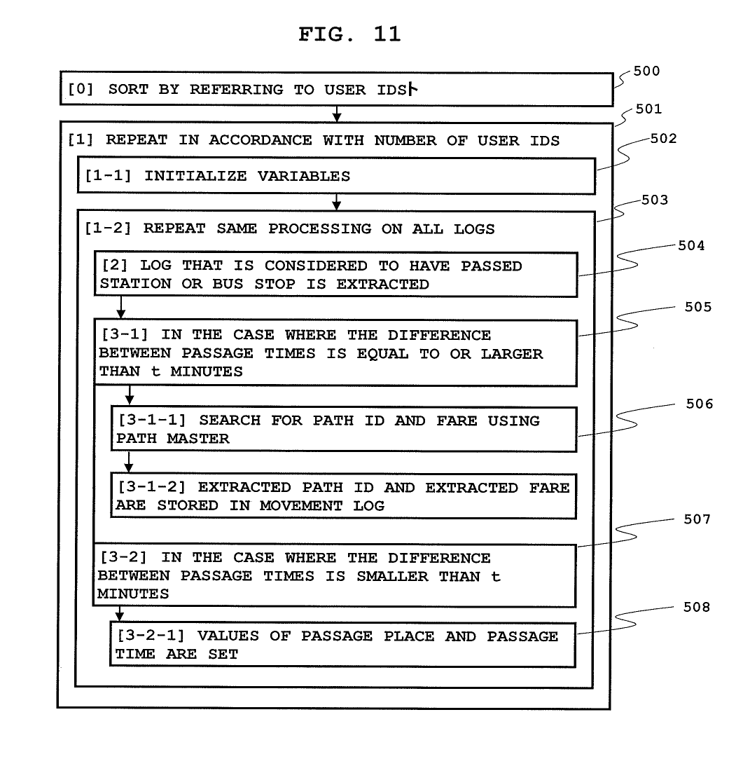

FIG. 11 is a diagram for explaining a procedure for generating Movement Log Data (125) from position data (123) at the usage time of a transport means and for storing the generated Movement Log Data (125) in the data server (111). In this case, the following description will be made under the assumption that the storage processing of Movement Log Data to the data server (111) is performed once a day at a predefined time. First, all data pieces are sorted in accordance with the order of user IDs and the order of times by referring to User ID (252) and Passage Time (255) included newly collected position data (123) at the usage time of a transport means (Processing Step 500). Next, the following same processing is repeated on the data sorted at Processing Step 500 in accordance with the number of user IDs (Processing Step 501). First, in order to store the contiguous data of Station/Bus Stop ID and Passage Time, list-type variables corresponding to Passage Station/Bus Stop ID and Passage Time are initialized (Processing Step 502). Next, the following same processing is repeated on the data sorted in accordance with times (Processing Step 503). A log that is considered to have passed the vicinity of a station or a bus stop is extracted on the basis of distance information with reference to Latitude Information (253), Longitude Information (254), Passage Time (255) included in position data (123) at the usage time of a transport means, and using Station/Bus Stop master (300), and values are set to Passage Station/Bus Stop ID and Passage Date respectively (Processing Step 504). Data pieces are recorded in the arrays of Passage Station/Bus Stop ID and Passage Time, and if the difference between the value of the last datum of Passage Time and the passage time of the log is equal to or larger than the threshold t (Processing Step 505), it can be considered that the movement is not continuing. Furthermore, because the path of the movement can be clarified by tracing the order of the list of Passage Station/Bus Stop ID, Path ID and a fare that coincide with the path are extracted from Path Master (Processing Step 506), and the extracted path ID and the extracted fare are stored in Movement Log Data (125). Data is stored in arrays of Passage Station/Bus Stop ID and Passage Time, and if the difference between the value of the last datum in the array of Passage Time and the passage time of the log is smaller than the threshold t (Processing Step 507), because the movement is continuing, values are set to the variables of Passage Station/Bus Stop ID and Passage Time respectively (Processing Step 508). Here, Log ID (361) of movement log data (125) is held as a serial number. Here, the value of t is a value representing a temporal space between plural movements, and it will be assumed that the value of t is predefined. The degree of continuity between movements can be adjusted using the value of t. The threshold t is a positive value, and it can be set as a common value regardless of transport means or positions, or it can have different values for individual transport means or positions. In addition, in order to judge separation between two movements, it is conceivable that, when each user passes through his/her departure place or destination place, he/she inputs explicitly some kind of information using his/her mobile terminal.

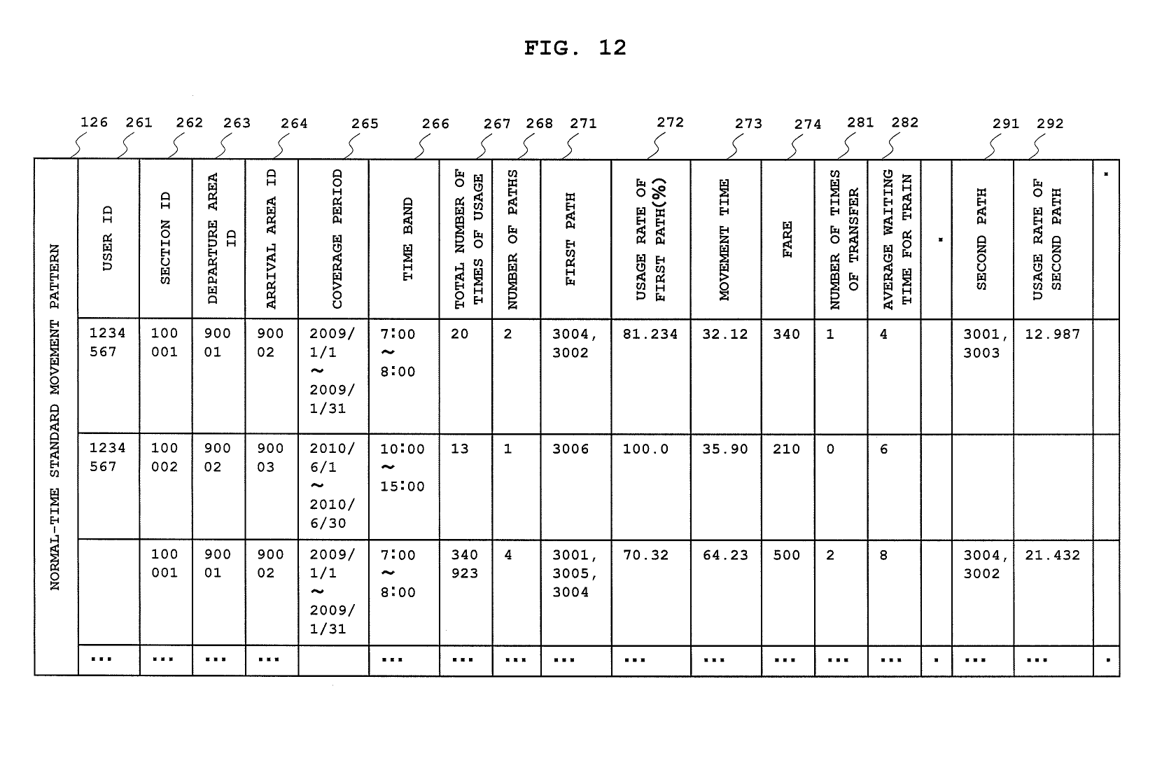

FIG. 12 is a diagram showing a data constitution for storing normal-time standard movement patterns which are calculated from movement logs. Normal-Time Standard Movement Pattern Data (126) includes information about User ID (261); Section ID (262) that identifies individual sections; Departure Area ID (263) that shows departure places; Arrival Area ID (264) that shows arrival places; Coverage Period (265) during which collection is performed; Time Band (266) during which collection is performed; Total Number of Times of Usage (267) that shows the number of times of movements between this section; Number of Paths (268), that is, the number of patterns used for moving between this section; First Path (271); Usage Rate of First Path (272); Average Movement Time of First Path (273); Fare of First Path (274); Number of Times of Transfer in First Path (281); Average Waiting Time for Train in First Path (282); Second Path (291); Usage Rate of Second Path (292); and the like. Characteristic information about each path is not limited to its average movement time, fare, number of times of transfer, average waiting time for train, and it is desirable to collect as many characteristics as possible.

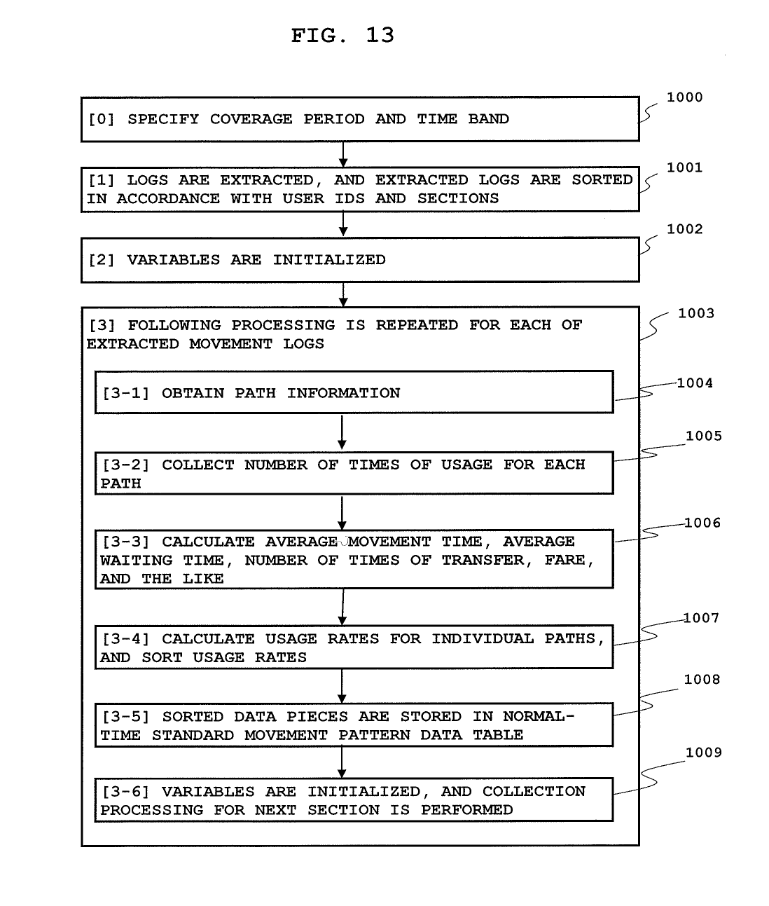

FIG. 13 is a diagram showing a processing procedure for extracting the movement pattern of each passenger and storing the extracted movement pattern in Normal-Time Standard Movement Pattern Data (126). First, logs that fall into a predefined coverage period and a predefined time band are extracted from Movement Log Data (125) (Processing Step 1000), and the extracted logs are sorted in accordance with each section which is a combination of User ID (362), Departure Area (365), and Arrival Area (366) (Processing Step 1001). In order to store the collection result of standard movement paths, list-type variables for Path ID and Number of Times of Usage are provided, and these variables are initialized (Processing Step 1002). Here, it is assumed that the values of coverage periods and time bands have been externally set in advance, therefore the same processing is performed on all combinations of the set data coverage periods and time bands. However, in this instance, an example of processing that is performed in the case of one combination of a data coverage period and a time band will be shown. The following processing is repeated on all the extracted records of movement logs for every user ID and every section (Processing Step 1003). Here, it is conceivable that, in the case of users who sufficiently many times traverses their coverage section during their coverage period, the collection processing is performed for each user and the collection result to which his/her user ID is attached is stored in Normal-Time Standard Movement Pattern Data Table. However, it can be expected that there is a passenger who hardly uses transport facilities at all during his/her coverage period, the passenger accidentally uses a transport facility when a transport failure of the transport facility occurs, and he/she is influenced by the transport failure, therefore it is desirable that normal-time movement pattern data pieces for the movement logs of all users are created in advance. This is because, if there are no normal-time movement patterns to be compared, it becomes difficult to correctly extract passengers who are influenced by a transport failure. In the case of creation of these standard movement pattern data pieces for all the users, collected results are stored in Standard Pattern Data Table in such a way that not existing user IDs but specific user IDs, which show that the standard movement pattern data pieces are for all the users, are assigned to the collected results, or user ID data pieces for the collected results are kept null. Next, for a movement log, which extracted and sorted for each user ID and each section, the number of times of usage is collected for each path by sequentially referencing (Processing Step 1004) to path information (368, 373, 376, and the like) (Processing Step 1005). After the above collection, information about an average movement time, an average waiting time, the number of times of transfer, a fare, and the like for each path is calculated, or generated by searching Master Data (Processing Step 1006). Here, the calculation of the average movement time and the average waiting time (average waiting time at transfer places) can be performed using data about a boarding date, and an exit date included in each movement log. The number of times of transfers and fares can be obtained by referring to movement logs or by searching Path Master Data (330). If videos of monitoring cameras installed in the premise of a station, and load compensation data prepared in each train can be used other than IC card data, congestion rates in the premise of the station and in each train can be calculated respectively, therefore it becomes possible to calculate the disutility value of each movement path due to the congestions. After characteristic amounts for individual paths are calculated in such a way, the usage rate for each path (the number of times of usage for each path total number of times of usage for the relevant coverage section×100) is calculated on the basis of the collection result about the numbers of times of usage for individual paths (Processing Step 107). Finally, the sorted data pieces are stored in Normal-Time Standard Movement Pattern Data Table (Processing Step 1008), and after the variables are initialized, collection processing for the next section is performed (Processing Step 1009). Although a path that is used frequently in a certain coverage section has been defined as a normal-time standard path in a certain coverage section so far, it is conceivable that, in the case of a commutation passenger, information about the section of his/her commutation ticket is adopted. Furthermore, in order to calculate a normal-time standard movement pattern as accurately as possible, it is desirable to use data at a place where and during a time band when transport is steady with reference to information about when and where the transport failure has occurred.

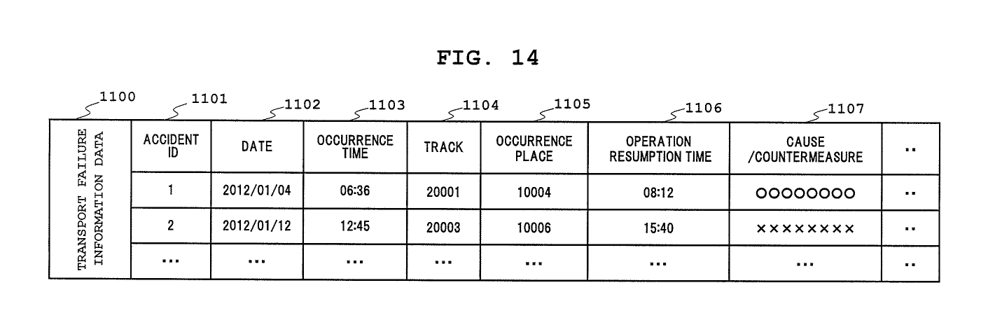

FIG. 14 is a diagram showing a data constitution for storing information about transport failures input by railroad operators and the like. Transport Failure Data Table (1100) includes information about Accident (Failure) ID (1101); Date (1102); Occurrence Time (1103); Accident (Failure) Occurrence Track (1104); Accident (Failure) Occurrence Place (1105) such as Station or Place between Stations; Operation Resumption Time (1106); Accident (Failure) Cause/Countermeasure (1107); and the like. Transport failure information can be input from a PC terminal or the like by a person in charge of a railroad company, or it can be mechanically extracted as service suspension information and a delay situation using actual diagram information stored in a traffic control system.

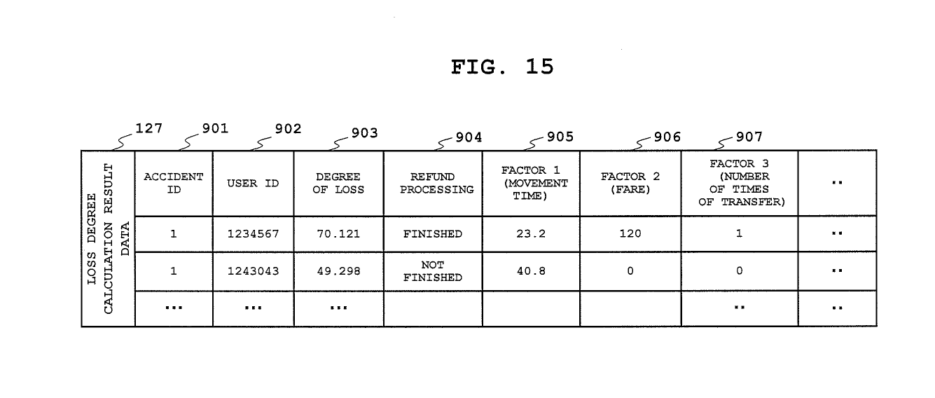

FIG. 15 is a diagram showing a data constitution for storing the degrees of losses obtained by analyzing the movement data of passengers who are affected by transport failures. Loss Degree Calculation Result Data Table (127) includes information about Accident ID (901); User ID (902); Degree of Loss (903); Flag about Refund Processing (904); Factor 1 (905); Factor 2 (906); Factor 3 (907); and the like. Flag about Refund Processing shows binary information that shows whether the processing is finished or not. In addition, although the following description will be made under the assumption that Factor 1 represents a movement time, Factor 2 a fare, and Factor 3 the number of times of transfer for simple explanation, the order and number of factors are not limited to three, and the larger the order and the number of factors are, the more multilaterally degrees of losses can be calculated.

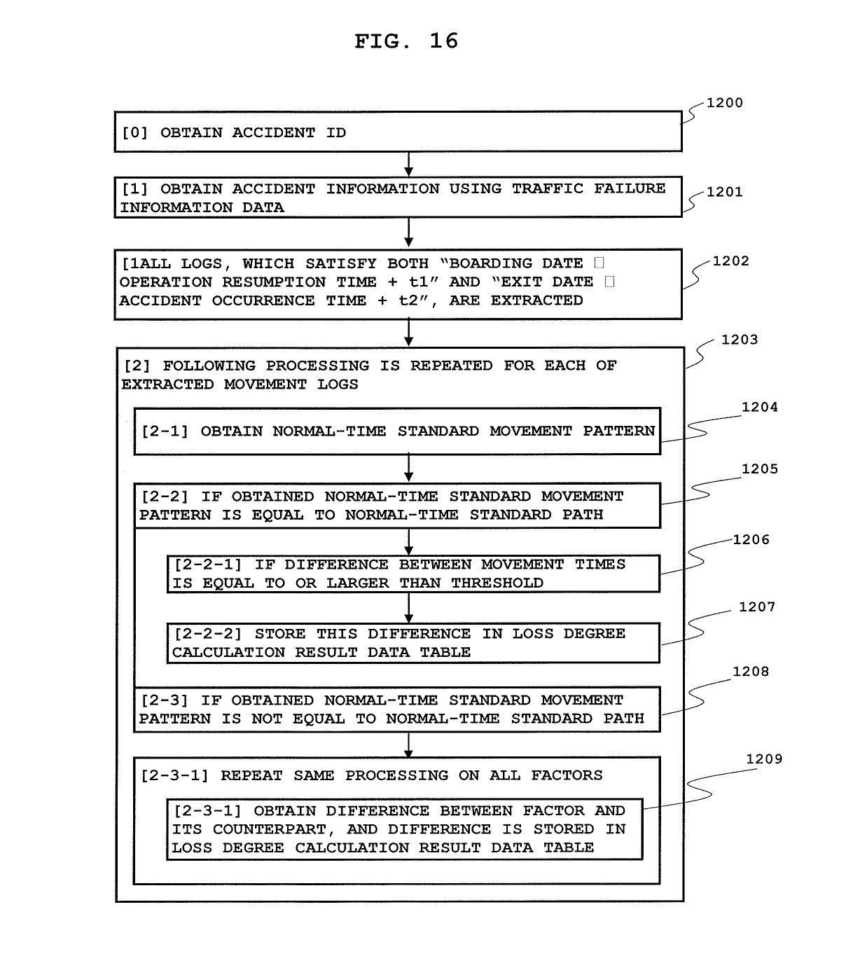

FIG. 16 is a diagram showing a processing procedure in which the movement patterns of individual passengers who are affected by a transport failure are extracted from movement logs, it is judged whether the passengers are affected by the transport failure or not by comparing the extracted movement patterns with normal-time standard movement pattern data, and the results are stored in Loss Degree Calculation Result Data Table (127). First, an accident ID, which is specified by a system operator or the like, is obtained (Processing Step 1200), and accident (failure) information about an accident (failure) Date (1102); Occurrence Time (1103); Accident (Failure) occurrence track (1104); an accident (failure) occurrence place (1105); an operation resumption time (1106); and the like is searched for from Traffic Failure Information Data Table (1100) on the basis of the accident ID (Processing Step 1201). All logs, which satisfy both “boarding date<operation resumption time+t1” and “exit date>accident (failure) occurrence time+t2”, are extracted from Movement Log Data Table (125) (Processing Step 1202), and the following processing is repeated on individual logs (Processing Step 1203). Here, t1 is a time period during which the influence of the accident (failure) remains from the accident (failure) occurrence, and t2 is a time period from the accident (failure) occurrence time to a time at which the influence of the accident (failure) is actualized. By setting the above conditions, it becomes possible to check off passengers, who are affected in time bands evidently unrelated to the accident, in advance from a group of passengers who are targets for the loss degree calculation. First, Normal-Time Standard Movement Pattern Data (126) is searched using information about User ID (362), Departure Area ID (365), Arrival Area ID (366) of Movement Log, and the relevant record is extracted (Processing Step 1204). If there is no record corresponding to the relevant user ID, the collected records of standard movement patterns of all users are brought out by considering all the users stored in Normal-Time Movement Pattern Data Table as targets. When the first path (272) of the extracted record is referred to the path information, if the first path (272) coincides with the path information (368, 373, . . . ) of the movement log at the time of the accident (Processing Step 1205), a time required (exit date−boarding date) for the movement log at the time of the accident is compared with the average movement time (273) of the relevant standard movement pattern, and if the difference between the time required and the average movement time is equal to or larger than a threshold (Processing Step 1206), the user ID and the difference between the movement times (the difference between the movement log and standard movement pattern information) is obtained, this difference is stored in Loss Degree Calculation Result Data Table (127) (Processing Step 1207). It will be assumed that this threshold is set uniquely by a transport operator or the like, and it can be adjusted for each accident or for each accident occurrence track. On the other hand, if the first path (272) of the record extracted from Normal-Time Standard Movement Pattern Data (126) does not coincide with the path information (368, 373, . . . ) of the movement log at the time of the accident (Processing Step 1208), the individual differences between the factors of normal-time standard movement pattern (path characteristics such as the movement time, the fare, the number of times of transfer) and the relevant individual factors of the movement log at the time of the accident are obtained, and if a difference between any factors is equal to or larger than the threshold, the relevant record is stored in Loss Degree Calculation Result Data Table (127) (Processing Step 1209). As is the case with Processing Step 1207, it will be assumed that the threshold is set uniquely by a transport operator or the like, and it can be adjusted for each accident or for each accident occurrence track. Furthermore, the rule of threshold can be applied to any one of factors, or a rule for judging whether there is an influence due to an accident or not can be made using a combination of plural factors. By calculating the difference between each factor of a normal-time standard movement pattern and the relevant factor of a movement log at the time of accident, how much this passenger is affected by an accident of analysis target can be quantitatively obtained. Factors that can be calculation targets are not limited to the above factors, and, for example, all things that can be measured, such as a moving distance on foot and a congestion degree in the premise of a station or in a train, can be targets. The larger the number of factors are, the more multilaterally the influence under which each passenger comes can be analyzed, therefore the accuracy of acquiring passengers who are affected by the transport failure can be more improved.

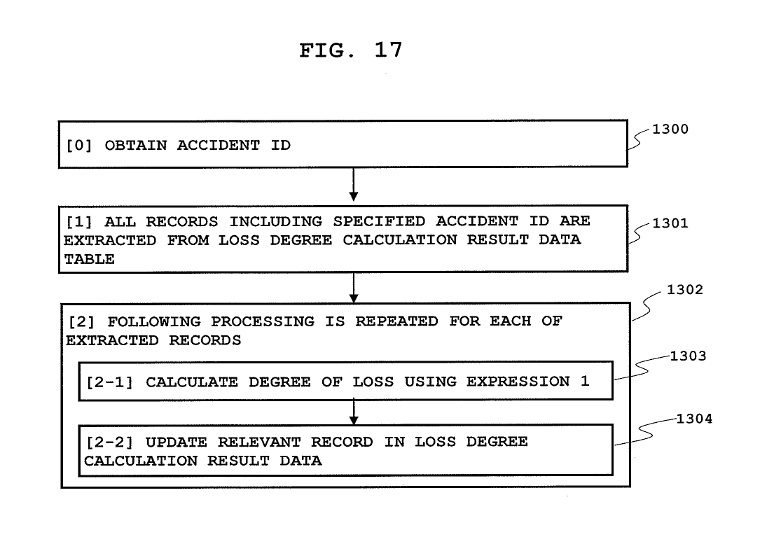

FIG. 17 is a diagram showing a processing procedure for calculating the degree of loss for a passenger who is judged to be affected due to a transport failure by the processing shown in FIG. 16, and storing the result in Loss Degree Calculation Result Data Table (127). This processing can be configured to be automatically performed every time the processing shown in FIG. 16 is performed, or this processing can be explicitly performed in association with the exchange of the calculation method of the degree of loss in accordance to the judgment of a system operator. First, an accident ID, which is specified by a system operator or the like, is obtained (Processing Step 1300), and all records including the specified accident ID are extracted from Loss Degree Calculation Result Data Table (127) (Processing Step 1301). The following processing is repeated on the extracted records (Processing Step 1302).

With the use of information about Factor 1 (905), Factor 2 (906), Factor 3 (907) included in a record in loss degree calculation result data and the next loss degree calculation expression defined in advance by a transport operator or the like, the degree of loss for each passenger is calculated (Processing Step 1303), and the calculation result is stored in the relevant record in Loss Degree Calculation Result Data Table (Processing Step 1304).

$$Loss = {\sum }_{i = 1}^{n} {C}_{i} \times {X}_{i} \qquad [ Expression 1 ]$$

This loss degree calculation expression is an example of a conversion expression for calculating the degree of loss using each factor, and, for example, there is another method in which coefficients are determined for individual factors in advance, and the total degree of loss is calculated by the linear sum of these coefficients. In addition, as a method for obtaining each coefficient, there is a technique in which, by comparing plural paths that move back and forth through the same section using their elements such as their average times required and fares, the weights for the individual elements are calculated. This technique is referred to as a logit model, and it is a technique for explaining for what reasons a passenger uses respective paths.

As for factors, as are clear from the above description, for example, factor 1 (905) included in Loss Degree Calculation Result Data Table (127) is a movement time; factor 2 a fare; and factor 3 the number of times of transfer. Other things that can be thought of as factors are a congestion degree, hours and minutes required for transfer on foot, and the like. In other words, one factor is a factor that is used in such a way that the factor is converted into a time, and a loss degree is obtained by multiplying the time (Xi) by the relevant coefficient (Ci in the loss degree calculation expression), another factor is a factor that can be obtained directly such as a fare in such a way that Ci=1, Xi=the fare, and another factor is a factor that Ci and Xi have to be decided in consideration of circumstances.

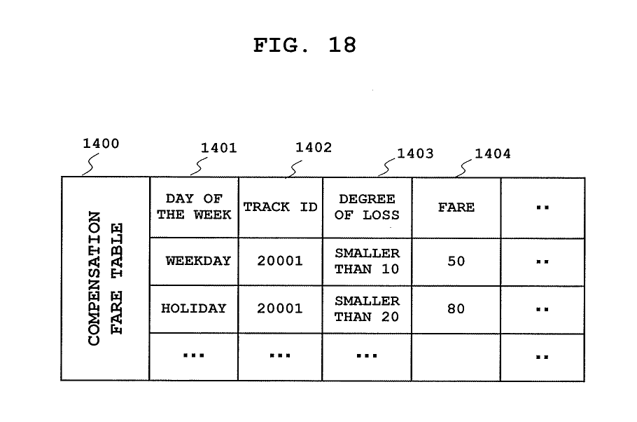

FIG. 18 is a diagram showing a data constitution for storing a money conversion table for refunding a fee in accordance with the degree of loss for a passenger. Compensation Fare Table (1400) includes information about Day of the Week (1401); Track ID (1402); Degree of Loss (1403); Fare (1404); and the like. This Compensation Fare Table is updated at regular intervals, and this Compensation Fare Table is prepared not only for Day of the Week, but also can be prepared for a time band, an operation stoppage period, or the cause of an accident occurrence. Furthermore, there is a way of converting the degree of loss into a point of an IC card or a credit card other than a way of converting the degree of loss into the amount of a refund fare.

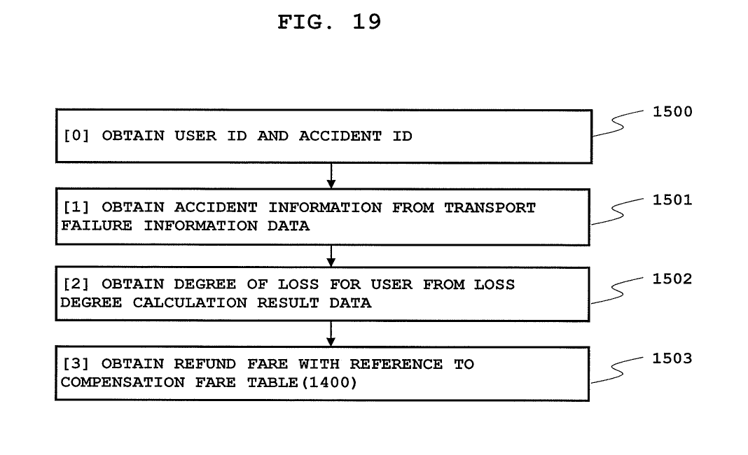

FIG. 19 is a diagram showing a processing procedure for calculating a refund fare from the degree of loss. This processing can be configured to be automatically performed every time the processing shown in FIG. 16 or FIG. 17 is performed, or this processing can be performed at the timing of Compensation Fare Table (1400) being updated or at the timing of refund processing for each passenger being performed. First, information about a user ID and an accident ID that are specified by a process executed by a system operator or by a request from a passenger is obtained (Processing Step 1500). Next, accident information is obtained from Transport Failure Information Data Table (1100) using the specified accident ID as a key (Processing Step 1501). In addition, the degree of loss for the relevant passenger is obtained from Loss Degree Calculation Result Data Table (127) using the specified user ID as a key (Processing Step 1502). Finally, a refund fare is obtained using the accident ID, the accident information, and the loss degree data with reference to Compensation Fare Table (1400) (Processing Step 1503).

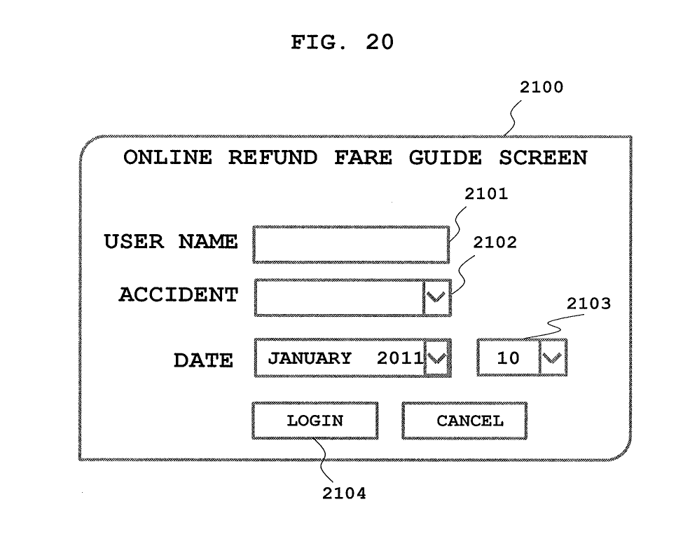

FIG. 20 is one example of a presentation screen which is generated and delivered for passengers by the information delivery server (113), and a diagram showing an example of online refund fare guidance. A user (115 or 117) inputs User Name (2101), Accident Case (2102) that is a search target, a date (2103), and the like on Online Refund Fare Guide Screen (2100) or selects them using pull-down menus, and pushes Login Button (2104), with the result that the request from the user is transmitted to the information delivery server (113). It will be assumed that these display conditions can be set or changed by the user (115 or 117) using an input interface such as a setting screen, a mouse, or a keyboard. Here, the user name (2101) can be an ID number of an IC card, or an account name that is uniquely associated with the ID number. Furthermore, the equivalent to information that is obtainable from the online refund fare guidance can be automatically delivered via mail to users whose mail addresses have been registered in advance. Choices of Accident Cases (2102) are pieces of letter string information that explicitly represents transport failure information about accident target tracks, dates, time bands, and the like, and a user manually selects an accident target, refund fare information about which the user wants to check, out of the list. In this case, it is conceivable that a list of accidents that are targets of refund relevant to the user is made at the timing of the user name (2101) being input by extracting records including the input user ID with reference to loss degree calculation result data (127). There are many cases where it is sufficient to select either the accident case (2102) or the date (2103), and the input work can be stopped at the time when the user can specify an accident case which he/she wants to search for. If the input user name (2101) is memorized in the information delivery server (113) when the user (115 or 117) first accesses Online Refund Fare Guide Screen, the input of the user name can be omitted the next time or later.

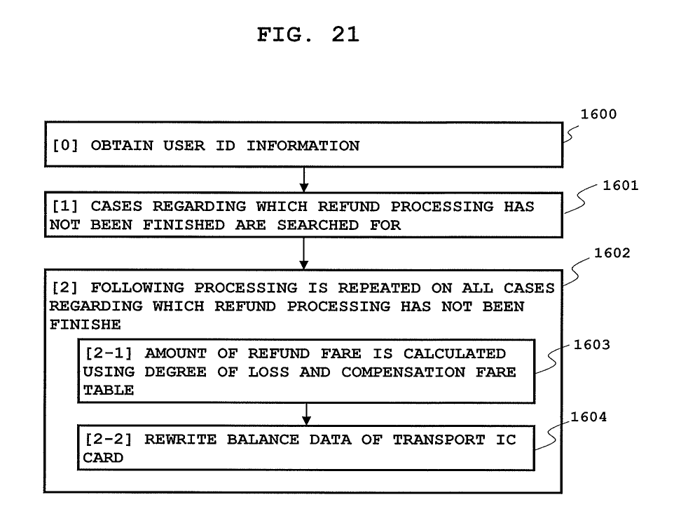

FIG. 21 is a diagram showing a processing procedure for performing refund processing for a passenger. This processing is performed at the timing when a request is issued by the user (115 or 117), or at the timing when, in the case of some transport failure occurs, the user (115 or 117) first holds up his/her IC card to an automatic ticket gate, a dedicated IC card reader, a high-functioning mobile phone with an IC card reader/writer function, or the like after loss degree calculation processing regarding the accident is finished. First, information about a user name (2101) input on Online Refund Fare Guide Screen (2100) is obtained (Processing Step 1600). Next, Loss Degree Calculation Result Data Table (127) is searched using a user ID that is obtained by converting the user name (2101) as a key, and accident cases regarding which refund processing has not been finished are extracted with reference to information about Refund Processing Flag (394) (Processing Step 1601). If there are some accident cases regarding which refund processing has not been finished, the following processing is repeated on all these accident cases (Processing Step 1602). First, the amount of a refund fare is calculated using the degree of loss included in a record of Loss Degree Calculation Result Data Table (127) and Compensation Fare Table (1400) (Processing Step 1603), and the balance record of the IC card possessed by the user (115 or 117) is rewritten (Processing Step 1604). Herewith, the refund processing is finished.

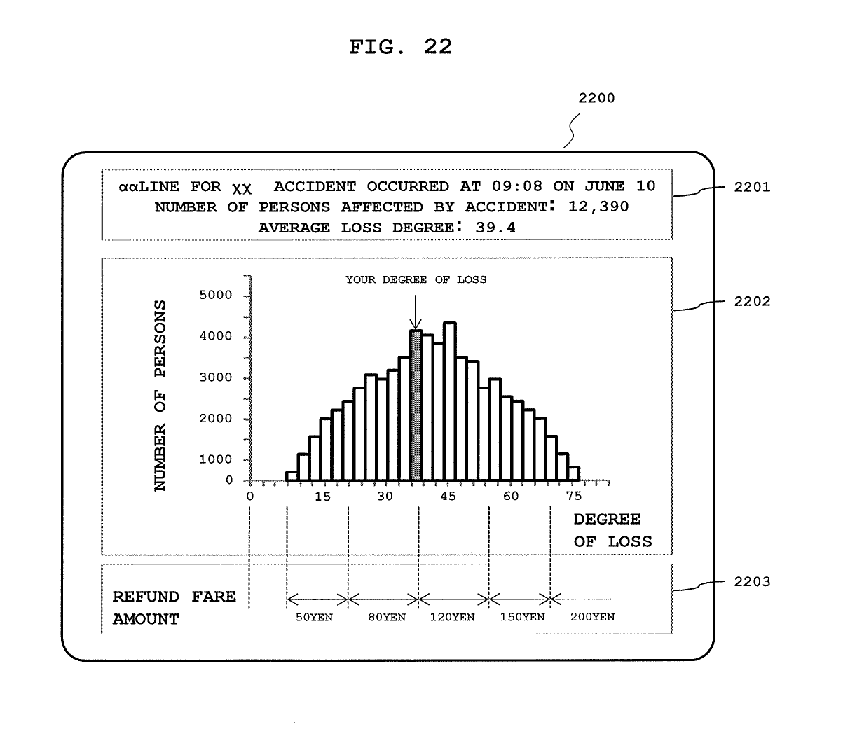

FIG. 22 is one example of a presentation screen generated and delivered for passengers by the information delivery server (113), and a diagram showing an example of a screen (2200) for illustrating calculation reasons for refund fares. The screen (2200) is, for example, includes accident information (2201), a loss degree distribution (2202), and a refund fare amount distribution (2203), and it is a screen with reference to which a passenger affected by an accident understands the degree of his/her loss and the amount of a refund fare he/she receives due to the accident in comparison with the cases of all passengers who are affected by the accident. The accident information (2201) is displayed by a display method in which accident information included in Transport Failure Data Table (1100), and the average loss degree of all the passengers calculated from Loss Degree Calculation Result Data Table (127), or the like are displayed. In addition, as a method in which a relative value is displayed in the all passengers, there is a method in which records of all the passengers affected by a target accident are calculated from Loss Degree calculation Result Data Table (127), and a histogram whose horizontal axis represents the degree of loss, and whose vertical axis represents the number of people is created and displayed. Furthermore, by obtaining information about the amounts of refund fares from Compensation Fare Table (1400), and by displaying the obtained information on the same screen, the degree of loss and the amount of a refund fare corresponding to the degree of loss for each passenger can be presented in a way he/she can be easily understood. These screens can be manipulated using an input interface such as a mouse or a keyboard and, for example, the screens can be zoomed in or zoomed out by a wheel button or the like, and the interval of the loss degree histogram can be changed by clicking a mouse. In addition, the type of the graph is not limited to the type of a bar graph, but it can be the type of a scatter graph or a line graph.

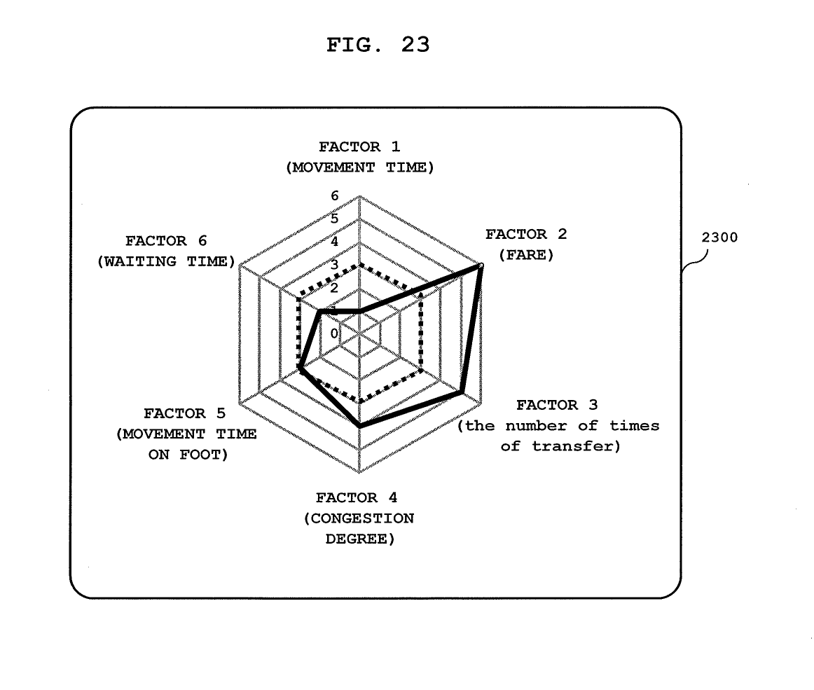

FIG. 23 is another example of a presentation screen which is generated and delivered for passengers by the information delivery server (113), and a diagram showing an example of a screen (2300) for explaining the calculation results of refund fares. As a method for explaining the calculation results of the degree of loss and a refund fare due to an accident, there is, for example, a method in which a difference between each factor of a influenced movement log and that of the relevant normal-time standard movement pattern data is plotted on a radar chart or the like with reference to, for example, Loss Degree Calculation Result Data Table (127). In this case, it is desirable that, difference data pieces for each factor regarding all passengers, who are affected by the accident, are extracted, and after an average difference value for each factor is calculated, the relative value is plotted in comparison with the degree of loss each passenger suffered. For example, in the case where even if a factor representing a movement time has a small difference from the average value regarding all the passengers, a factor representing a fare has a large difference from the average value regarding all the passengers, the reason that the amount of a refund fare becomes large because the relevant passenger suffers a considerable degree of loss in terms of the fare although he/she suffers little degree of loss in terms of the movement time can be easily understood.

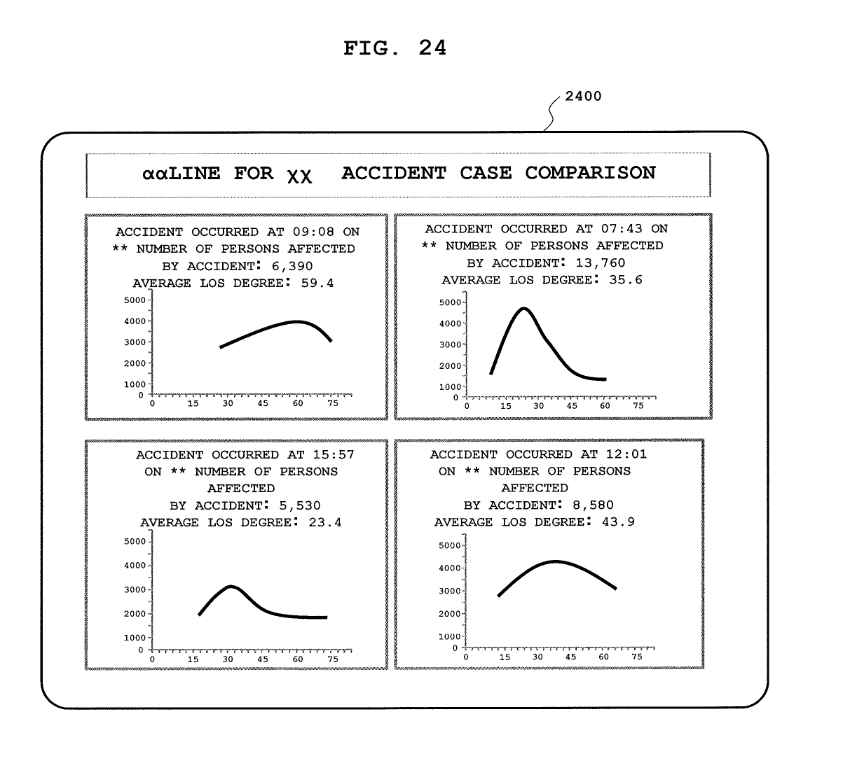

FIG. 24 is one example of a presentation screen (2400) generated and delivered to a system operator and a person in charge of a transport operator by the information delivery server (113), and a diagram showing an example of a screen on which plural transport failure cases are displayed and the loss degree distributions of individual accident cases are visualized so that they can be compared with one another. The screen (2400) is used, for example, in such a way that, after an accident occurrence site and an accident occurrence time band in a certain track or in a certain quarter are specified, accident cases having conditions similar to the condition of the above accident are collected and displayed on the screen, and operational countermeasures are reviewed by comparing individual loss degree distributions with one another. A case where the number of persons affected by an accident is large but the loss per person is small, or a case where the number of persons affected by an accident is small but the loss per person is large can be found out by paying attention to the peak values of the loss degree distributions, with the result that a deep analysis can be performed.

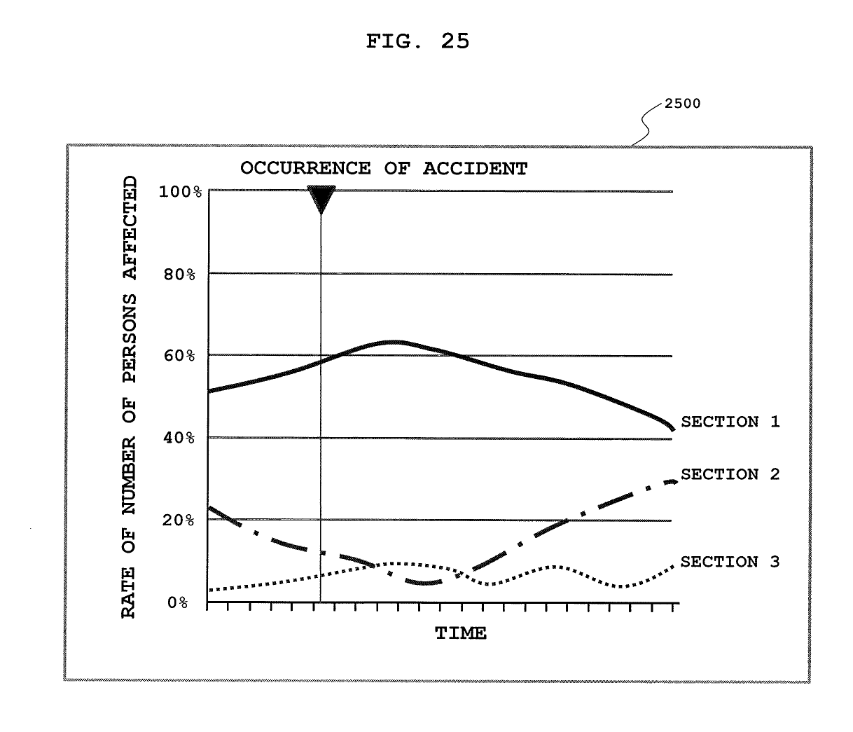

FIG. 25 is one example of a presentation screen (2500) generated and delivered to a system operator and a person in charge of a transport operator by the information delivery server (113), and a diagram showing an example of a screen on which the degrees of losses passengers suffered by a certain transport failure case are visualized so that they can be analyzed in detail for individual sections. The screen (2500) is an example of a screen on which the changes of the degrees of losses for passengers who uses various sections are displayed in time series, so that it is possible to observe how influences have spread since the occurrence of the accident for the individual sections. A value assigned to the vertical axis can be a ratio of the number of persons affected by the accident to the number of users for each section, or can be the average loss degree or the average amount of a refund fare per person. It is conceivable that designation of which section to be observed, and the display resolution of the time axis are configured to be freely operable by a mouse or the like, and an area which can be set or checked is prepared in a way that the area is attached to this screen (2500). If the usage data of a transport facility can be collected in real time, it is possible to momentarily monitor influences associated with the occurrence of an accident, so that, for example, there is a method in which, while attention is paid to a station or a section that are largely influenced by the accident, countermeasures for the station or the section are taken on a priority base.

It will be assumed that information for generating the presentation screens shown in FIG. 20, FIG. 22, FIG. 23, and FIG. 24 is stored in the memory (133) of the calculation server (112); the user check program (141) and the refund processing program (142) are executed in accordance with a condition that is specified by a system operator (119) or a person in charge of an transport company who accesses a predefined Web page and selects an item using pull down menus or the like; and necessary information is obtained. As a result, information acquired by the information delivery program (143) is edited, and the edited information is delivered.

As described above, complaints of passengers can be resolved by analyzing the movement data of users of transport means; quantitatively calculating the degrees of losses passengers, who are influenced by a transport failure, suffer; calculating the amounts of refund fares corresponding to the degrees of losses; and performing refund processing, so that the improvement of traveler services offered by transport operators are realized, and at the same time, burdens imposed on station attendants and others can be alleviated.

According to this embodiment, time, cost, and others can be reflected in a refund fare in association with the degree of loss obtained by comparing the influenced movement log of a passenger and the standard movement pattern. Because an influenced movement log and a standard movement pattern can be acquired for each passenger, an actual situation of an influence each passenger suffers can be reflected in his/her refund fare.

Furthermore, according to this embodiment, because refund processing is performed at the timing of each passenger using his/her IC card after a transport failure is settled, a burden imposed on the passenger regarding refund processing such as reception of a transport transfer ticket is alleviated or eliminated.

In addition, according to this embodiment, because passengers affected by a transport failure can be automatically extracted using transport IC ticket data and position information data, a burden imposed on a station attendant can be alleviated.

Although the embodiments of the present invention have been described so far, the present invention is not limited to the above-described embodiments, and it to be understood by those skilled in the art that various modifications may be made and the above-described embodiments may be appropriately combined.

### LIST OF REFERENCE SIGNS

01˜07 . . . Station, 11˜14 . . . Track, 21˜23 . . . Path, 101 . . . User, 102 . . . Automatic Ticket Gate, 103 . . . IC card, 104 . . . User, 105 . . . Network, 106 . . . External Data Server, 107 . . . Fare Refund System, 108 . . . Monitoring Camera, 111 . . . Data Server, 112 . . . Calculation Server, 113 . . . Information Delivery Server, 114 . . . Internet, 115 . . . User, 116 . . . Mobile Information Terminal, 117 . . . User, 118 . . . Information Terminal, 119 . . . Transport Operator, 120 . . . Information Terminal, 121 . . . Data Storage Unit, 122 . . . IC Card Data, 123 . . . Position Data at the Usage Time of a Transport Means, 124 . . . Master Data, 125 . . . Movement Log Data, 126 . . . Normal-Time Standard Movement Pattern Data, 127 . . . Loss Degree Calculation Result Data, 130 . . . Network Interface, 131 . . . CPU, 132 . . . Memory, 133 . . . Memory Unit, 134 . . . Movement Log Generation Program, 135 . . . Normal-Time Standard Movement Pattern Calculation Program, 136 . . . Failure Influence Judgment Program, 137 . . . Failure-Time Loss Degree Calculation Program, 138 . . . Compensation Fare Calculation Program, 139 . . . Data Storage Unit, 141 . . . User Check Program, 142 . . . Refund Processing Program, 143 . . . Information Delivery Program, 145 . . . Network Interface, 146 . . . CPU, 147 . . . Memory, 148 . . . Memory Unit, 151 . . . Network, 161 . . . Transport Failure Information Data, 162 . . . Failure Area and Failure Time Band, 163 . . . Candidates of Passengers Influenced by Accident, 164 . . . Loss Degree Associated with a Failure, 241 . . . Log ID, 242 . . . User ID, 243 . . . Station/Bus Stop ID, 244 . . . Usage Time, 245 . . . Usage Type, 251 . . . Log ID, 252 . . . User ID, 253 . . . Latitude, 254 . . . Longitude, 255 . . . Passage Time, 261 . . . User ID, 262 . . . Section ID, 263 . . . Departure Area ID, 264 . . . Arrival Area ID, 265 . . . Coverage Period, 266 . . . Time Band, 267 . . . Total Number of Times of Usage, 268 . . . Number of Paths, 271 . . . First Path, 272 . . . Usage Rate of First Path, 273 . . . Average Movement Time, 274 . . . Fare, 281 . . . Number of Times of Transfer, 282 . . . Average Waiting Time for Train, 291 . . . Second Path, 292 . . . Usage Rate of Second Path, 300 . . . Station/Bus Stop Master, 301 . . . Station/Bus Stop ID, 302 . . . Station/Bus Stop Name, 303 . . . Proprietary Company, 304 . . . Location, 305 . . . Latitude/Longitude, 310 . . . Track Master, 311 . . . Track ID, 312 . . . Track Name, 313 . . . Operation Company, 314 . . . Track Type, 320 . . . Relation between Station/Bus Stop and Track Master, 321 . . . Track ID, 322 . . . Station/Bus Stop ID, 323 . . . Sequence Number, 324 . . . Type, 325 . . . Times Required from Starting Point, 330 . . . Path Master, 331 . . . Path ID, 332 . . . Boarding Station/Bus Stop ID, 333 . . . Exit Station/Bus Stop ID, 334 . . . Track ID1, 335 . . . Transfer Station/Bus Stop ID1, 336 . . . Path ID2, 341 . . . Number of Boarding Tracks, 342 . . . Standard Time Required, 343 . . . Fare, 361 . . . Log ID, 362 . . . User ID, 363 . . . Boarding Date, 364 . . . Exit Date, 365 . . . Departure Area ID, 366 . . . Arrival Area ID, 367 . . . Amount Paid, 368 . . . Path ID1, 371 . . . Boarding Station/Bus Stop ID1, 372 . . . Exit Station/Bus Stop ID1, 373 . . . Path ID2, 374 . . . Boarding Station/Bus Stop ID2, 375 . . . Exit Station/Bus Stop ID2, 376 . . . Path ID3, 400˜413 . . . Processing Step, 500˜508 . . . Processing Step, 701 . . . Station, 702 . . . Bus Stop, 703˜704 . . . Station, 705˜706 . . . Bus Stop, 707 . . . Station, 711˜712 . . . Railroad Track, 713˜714 . . . Bus Track, 800 . . . Area Definition List, 801 . . . Area ID, 802 . . . Representative Station/Bus Stop ID, 803 . . . Coverage Period, 804 . . . Number of Stations/Bus Stops, 805 . . . Station/Bus Stop ID1, 806 . . . Station/Bus Stop ID2, 807 . . . Station/Bus Stop ID3, 808 . . . Station/Bus Stop ID4, 901 . . . Accident ID, 902 . . . User ID, 903 . . . Degree of Loss, 904 . . . Refund Processing, 905 . . . Factor 1, 906 . . . Factor 2, 907 . . . Factor 3, 1000˜1009 . . . Processing Step, 1100 . . . Transport Failure Information Data, 1101 . . . Accident ID, 1102 . . . Date, 1103 . . . Occurrence Time, 1104 . . . Track, 1105 . . . Occurrence Place, 1106˜Operation Resumption Time, 1107 . . . Cause/Countermeasure, 1200˜1209 . . . Processing Step, 1301˜1304 . . . Place where a Transport Means Can Be Used, 1400 . . . Compensation Fare Table Data, 1401 . . . Day of the Week, 1402 . . . Track ID, 1403 . . . Degree of Loss, 1404 . . . Fare, 1500˜1503 . . . Processing Step, 1600˜1604 . . . Processing Step, 2100 . . . Online Refund Fare Guide Screen, 2101 . . . User Name, 2102 . . . Accident Case, 2103 . . . Date, 2104 . . . Login Button, 2200 . . . Screen for Illustrating Calculation Reasons for Refund Fares, 2201 . . . Accident Information, 2202 . . . Loss Degree Distribution, 2203 . . . Refund Fare Amount, 2300 . . . Screen for Explaining Calculation Results of Refund Fares, 2400 . . . Plural Accident Case Comparison Screen, 2500 . . . Rate of Number of Persons Affected for Each Section Display Screen.

1. A fare refund system comprising:
a standard movement pattern generation unit for collecting a movement log of a passenger utilizing a transport facility and generating a standard movement pattern of the passenger on the basis of a normal-time movement log of the transport facility in the collected movement log;
a transport failure information acquisition unit for acquiring information about a failure influenced area and a failure influenced time band associated with the development of a transport failure by the transport facility;
an influence presence/absence determination unit for determining the presence or absence of an influenced movement log in the collected movement log which is the movement log of the passenger in the transport failure area and the failure influenced time band;
a loss degree calculation unit for calculating the degree of loss for the passenger associated with the transport failure on the basis of a difference between the standard movement pattern and the influenced movement log when it is determined by the influence presence/absence determination unit that there is the influenced movement log; and
a refund unit for paying back a refund fare corresponding to the calculated loss degree and associated with the development of the transport failure by the transport facility.

2. The fare refund system according to claim 1, wherein the standard movement pattern of the passenger is a path shown by a movement log that is the most frequently used in the movement logs that show paths through which the passenger moves from a predefined departure place to a predefined arrival place using the transport facility.

3. The fare refund system according to claim 2, wherein the standard movement pattern generation unit generates the movement log of the passenger on the basis of data specifying the passenger and the position information of the passenger.

4. The fare refund system according to claim 3, wherein the data specifying the passenger and the position information of the passenger is either data that is read out from the IC card of the passenger and specifies the passenger, and the position information of a readout device that reads out the data specifying the passenger respectively; or data that specifies the passenger on the basis of video data of the passenger and the information of a position where the video data of the passenger is obtained respectively.

5. The fare refund system according to claim 2, wherein the refund unit delivers online refund fare guidance screen information about the refund fare of the passenger and screen information for explaining the calculation reason of the refund fare of the passenger to the passenger.

6. The fare refund system according to claim 2, wherein the refund unit delivers screen information for the distribution of the degree of loss for each case of a plurality of transport failures including the transport failure, and screen information, which is used for displaying the degrees of losses for passengers including the passenger associated with the transport failure for each transport section operated by the transport facility, to a proprietor of the transport facility.

7. A fare refund method used for a fare refund system for paying back a refund fare associated with the development of a transport failure by a transport facility, the fare refund method comprising the steps of:
collecting a movement log of a passenger utilizing the transport facility and generating a standard movement pattern of the passenger on the basis of a normal-time movement log of the transport facility in the collected movement log;
acquiring information about a failure influenced area and a failure influenced time band associated with the development of the transport failure by the transport facility;
determining the presence or absence of an influenced movement log in the collected movement log which is the movement log of the passenger in the transport failure area and the failure influenced time band;
calculating the degree of loss for the passenger associated with the transport failure on the basis of a difference between the standard movement pattern and the influenced movement log when it is determined by the influence presence/absence determination unit that there is the influenced movement log; and
paying back a refund fare corresponding to the calculated loss degree and associated with the development of the transport failure by the transport facility.

8. The fare refund method according to claim 7, wherein the standard movement pattern of the passenger is a path shown by a movement log that is most frequently used in the movement logs that show paths through which the passenger moves from a predefined departure place to a predefined arrival place using the transport facility.

9. The fare refund method according to claim 8, the fare refund method further comprising a step of:
generating the movement log of the passenger on the basis of data specifying the passenger and the position information of the passenger.

10. The fare refund method according to claim 9, wherein the data specifying the passenger and the position information of the passenger is either data that is read out from the IC card of the passenger and specifies the passenger, and the position information of a readout device that reads out data specifying the passenger respectively; or data that specifies the passenger on the basis of video data of the passenger and the information of a position where the video data of the passenger is obtained respectively.

11. The fare refund method according to claim 8, the fare refund method further comprising a step of:
delivering online refund fare guidance screen information about the refund fare of the passenger and screen information for explaining the calculation reason of the refund fare of the passenger to the passenger.

12. The fare refund method according to claim 8, the fare refund method further comprising a step of:
delivering screen information for the distribution of the degree of loss for each case of a plurality of transport failures including the transport failure, and screen information, which is used for displaying the degrees of losses for passengers including the passenger associated with the transport failure for each transport section operated by the transport facility, to a proprietor of the transport facility.
